(19) United States
(12) Patent Application Publication
(10) Pub. No.: US 2026/0011149 A1
(43) Pub. Date: Jan. 8, 2026

(54) CONTEXT-AWARE VIDEO RETRIEVAL AND INFERENCE SYSTEM

(71) Applicant: NVIDIA Corporation, Santa Clara, CA (US)

(72) Inventors: Shivam LAKHOTIA, Sunnyvale, CA (US); Prashant Champalal GAIKWAD, San Jose, CA (US); Ashwani AGARWAL, San Jose, CA (US); Parthasarathy SRIRAM, Los Altos Hills, CA (US)

(73) Assignee: NVIDIA Corporation, Santa Clara, CA (US)

(21) Appl. No.: 19/258,036

(22) Filed: Jul. 2, 2025

Related U.S. Application Data
(60) Provisional application No. 63/668,140, filed on Jul. 5, 2024.

(51) Int. Cl. G06V 20/40; G06F 16/735; G06V 10/70

(52) U.S. Cl. CPC G06V 20/44; G06F 16/735; G06V 10/768; G06V 20/41; G06V 20/49; G06V 2201/10

(57) ABSTRACT

Various examples, systems, and methods are disclosed relating to an agentic curation pipeline. One system can process questions and other inquiries about video content by using a combination of models and stored information. The system can receive a query related to an event in a video, selects relevant portions of the video using embeddings, and apply the selected video data and a related sub-query to a video model. The output from the video model can be used by a language model, along with stored context, to generate an answer to the original query. The system can returns the answer to the requester.

### CROSS-REFERENCE TO RELATED APPLICATIONS

The present application claims the benefit of U.S. Provisional Patent Application No. 63/668,140, filed Jul. 5, 2025, the disclosure of which is incorporated herein by reference in its entirety.

### BACKGROUND

Querying vision-language model (VLM) systems for context-relevant responses presents challenges. Some existing systems rely on direct prompting of large language models (LLMs) without leveraging the semantic structure of video metadata and/or contextual relationships derived from videos. These approaches often fail to resolve latent relationships across video segments, resulting in limited understanding of temporal patterns, object interactions, and/or event continuity. Many systems lack mechanisms for selecting domain-relevant models, indexing semantically meaningful metadata, and/or retrieving structured context associated with prior outputs. These limitations reduce system accuracy when performing query-dependent video reasoning and inhibit interaction across long-term and short-term memory contexts during inference.

### SUMMARY

Implementations of the present disclosure relate to context-aware video retrieval and inference system. Systems and methods are disclosed that model multimodal queries using video and language models to retrieve embeddings, perform semantic inference over temporally indexed content, and/or generate natural language responses based at least on retrieved and updated context data.

In contrast to conventional systems, implementations of the present disclosure relate to systems and methods for facilitating multimodal data interactions between large language models (LLMs), vision language models (VLMs), associated embedding subsystems, graph neural networks, and/or databases or data storages. For example, systems and methods in accordance with the present disclosure can receive a query corresponding to an event in at least one video sequence and generate responses to address such queries using outputs from one or more models, e.g., multiple models orchestrated to generate the responses. That is, at least one query can be used to retrieve embeddings, generate video model outputs, and/or update context representations based at least on token-level and/or embedding-level interactions. The system can apply retrieval-augmented generation (RAG) techniques in which the LLM functions as a coordinating agent that can apply queries to access short-term and long-term context data, can generate additional queries for the VLM, and/or can interpret results returned by the VLM and/or another model or system to generate an output response. That is, the systems and methods can apply embeddings and query prompts to VLMs and/or another model, generate one or more outputs corresponding to semantic interpretations of video content, and/or apply the outputs to LLMs to generate natural language responses, instructions, and/or function calls. This can allow the system to maintain agentic operation across language and video modalities.

In some implementations, the systems and methods can generate embeddings from video sequences using segmentation parameters and sampling techniques. The embeddings can correspond with labels and/or metadata extracted by the VLM and stored in data structures indexed by identifiers. Additionally, graph representations can be generated from model outputs to represent labels and/or relationships between labels, such as object co-occurrence and/or temporal activity links. The representations can be queried and used to identify relevant embeddings or to generate follow-up queries for additional inference. In some implementations, LLMs can access and/or update system context, long-term context, and short-term context to improve response quality and maintain a historical interaction state. These implementations improve orchestration of VLM and LLM model workflows, provide structured query handling using multimodal inputs, and/or provide improved context-aware analysis across video content and textual queries. In some implementations, the graph representations can be queried using agent-issued follow-up queries, which can apply graph traversal and label-matching to identify relevant embeddings (e.g., video, images, and/or other embeddings).

Some implementations relate to a system including one or more processors to execute operations. The operations including receive a first query corresponding to an event at least partially depicted in at least one video sequence. The operations including apply at least one video embedding and a second query corresponding to at least one language model as input to at least one video model to cause the at least one video model to generate a first output corresponding to the second query. The operations including apply the first output as input to the at least one language model to cause the at least one language model to generate a second output corresponding to the first query.

In some implementations, the one or more processors are further to execute operations including apply the first query as input to the at least one language model to cause the at least one language model to generate the second query corresponding to at least one function to perform. In some implementations, the at least one language model is to generate the second output based at least on context data corresponding to at least one of (i) a system context, (ii) a long-term context, or (iii) a short-term context.

In some implementations, the one or more processors execute operations to generate the second query including causing the at least one language model to access at least one of (i) the system context, (ii) the long-term context, or (iii) the short-term context by retrieving, from a memory storage, at least one of: (i) at least one token corresponding to the system context or the long-term context, (ii) a summary of one or more historical queries, or (iii) a queue of one or more recent queries. In some implementations, the one or more processors are further to execute operations including update the long-term context based at least on applying at least one input to at least one of: (i) the at least one language model, (ii) the at least one video model, or (iii) an embedding system. In some implementations, the one or more processors are further to execute operations including update the short-term context based at least on a plurality of queries received.

In some implementations, the one or more processors are further to execute operations including obtain a model-compatible representation of video data corresponding to the at least one video sequence. In some implementations, the one or more processors are further to execute operations including segment a plurality of frames of the video data in the model-compatible representation into a plurality of video segments based at least on one of a segmentation parameter corresponding to a domain of the at least one video sequence or a frame sampling parameter. In some implementations, the one or more processors are further to execute operations including generate, using an embedding system, the plurality of embeddings based at least on the plurality of video segments. In some implementations, the plurality of embeddings correspond to a live video stream or recorded video data.

In some implementations, the one or more processors are further to execute operations including apply at least one of: (i) the plurality of embeddings, (ii) at least one caption, (iii) or at least a portion of a graph, as input to the at least one video model to cause the at least one video model to generate metadata corresponding to the video data In some implementations, the metadata includes at least one label indicating at least one object, action, scene attribute, or event class detected from a corresponding video embedding of the plurality of embeddings. In some implementations, the one or more processors are further to execute operations including store the metadata in a database indexed by at least one identifier corresponding to at least one of the plurality of embeddings.

In some implementations, the one or more processors are further to execute operations including generate a graph based at least on metadata, the graph including a plurality of nodes and a plurality of edges, the plurality of nodes representing a plurality of labels, and the plurality of edges representing a plurality of semantic relationships between at least two of the plurality of nodes. In some implementations, the one or more processors are further to execute operations including traverse the graph based at least on the second query to identify at least one node or at least one edge corresponding to a label of the plurality of labels or a semantic relationship of the plurality of semantic relationships. In some implementations, the one or more processors are further to execute operations including identify at least one embedding corresponding to a detected object, action, scene attribute, or event class represented by the identified at least one node or the identified at least one edge.

In some implementations, the one or more processors are further to execute operations including apply a third query corresponding to the at least one language model as input to the at least one video model to cause the at least one video model to generate a third output corresponding to the third query. In some implementations, the one or more processors are further to execute operations including identify, using the at least one language model, a timestamp and a duration based at least on the third output and context data. In some implementations, the one or more processors are further to execute operations including obtain, using an embedding system, at least one of an additional video embedding or corresponding metadata based at least on the timestamp and the duration. In some implementations, the one or more processors are further to execute operations including apply the at least one of the additional video embedding or the corresponding metadata and a fourth query corresponding to the at least one language model as input to the at least one video model to cause the at least one video model to generate a fourth output corresponding to the fourth query.

Some implementations relate to one or more processors including processing circuitry to receive a first query corresponding to an event in at least one video sequence. In some implementations, the processing circuitry to apply at least one video embedding identifier and a second query corresponding to at least one language model as input to at least one video model to cause the at least one video model to generate a first output corresponding to the second query. In some implementations, the processing circuitry to apply the first output as input to the at least one language model to cause the at least one language model to generate a second output corresponding to the first query, the at least one language model to generate the second output based at least on context data corresponding to at least one of the first query, the second query, the at least one video model, or the at least one language model.

In some implementations, the processing circuitry is further to apply the first query as input to the at least one language model to cause the at least one language model to generate the second query corresponding to at least one function to perform. In some implementations, the context data corresponds to at least one of: (i) a system context, (ii) a long-term context, or (iii) a short-term context. In some implementations, the processing circuitry is further to generate the second query including causing the at least one language model to access at least one of: (i) the system context, (ii) the long-term context, or (iii) the short-term context by retrieving at least one of: (i) at least one token corresponding to the system context or the long-term context, (ii) a summary of one or more historical queries, or (iii) a queue of one or more recent queries.

In some implementations, the processing circuitry is further to update the long-term context based at least on applying at least one input to at least one of: (i) the at least one language model, (ii) the at least one video model, or (iii) an embedding system. In some implementations, the processing circuitry is further to update the short-term context based at least on a plurality of queries received.

In some implementations, the processing circuitry is further to segment a plurality of frames of video data corresponding to the at least one video sequence into a plurality of video segments based at least on one of a segmentation parameter corresponding to a domain of the at least one video sequence or a frame sampling parameter. In some implementations, the processing circuitry is further to generate, using an embedding system, a plurality of video embeddings based at least on the plurality of video segments. In some implementations, the plurality of video embeddings correspond to a live video stream or recorded video data.

In some implementations, the processing circuitry is further to select the at least one video model from a plurality of video models based at least on the domain. In some implementations, the processing circuitry is further to apply at least the plurality of video embeddings as input to the at least one video model to cause the at least one video model to generate metadata corresponding to the video data. In some implementations, the metadata includes at least one label indicating at least one object, action, scene attribute, or event class detected from a corresponding video embedding of the plurality of video embeddings. In some implementations, the processing circuitry is further to store the metadata in a database indexed by at least one identifier corresponding to at least one of the plurality of video embeddings. In some implementations, the processing circuitry is further to generate a graph based at least on metadata, the graph including a plurality of nodes and a plurality of edges, the plurality of nodes representing a plurality of labels, and the plurality of edges representing a plurality of semantic relationships between at least two of the plurality of nodes.

Some implementations relate to a method. The method includes receiving, by one or more processors, a query corresponding to an event in at least one video sequence. The method includes generating, by the one or more processors using at least one video model, a first output based at least on at least one video embedding of a plurality of embeddings. The method includes generating, by the one or more processors using at least one language model, a second output corresponding to the query based at least on context data and the first output. The method includes providing, by the one or more processors, the second output.

The processors, systems, and/or methods described herein can be implemented by or included in at least one of a system implementing generation of embeddings based at least on domain-specific segmentation and sampling parameters, a system implementing context-aware retrieval-augmented generation over long-form video data, a system implementing multimodal query processing using one or more large language models (LLMs) and one or more vision-language models, a system implementing temporal alignment or semantic alignment between user queries and video segments using model-generated metadata, a system for updating a context responsive to language model queries, a system implementing one or more multi-modal language models (MMLMs), a system implementing the LLMs, a system implementing one or more small language models (SLMs), a system implementing one or more vision language models (VLMs), a system for generating synthetic data, a system for generating synthetic data using AI, a control system for an autonomous or semi-autonomous machine, a perception system for an autonomous or semi-autonomous machine, a system for performing digital twin operations, a system for performing light transport simulation, a system for performing remote operations, a system implemented using an edge device, a system implemented using a robot, a system for performing conversational AI operations, a system incorporating one or more virtual machines (VMs), a system implemented at least partially in a data center, or a system implemented at least partially using cloud computing resources.

### BRIEF DESCRIPTION OF THE DRAWINGS

The present systems and methods for context-aware video retrieval and inference system are described in detail below with reference to the attached drawing figures, wherein:

FIG. 1 is an example block diagram of system, in accordance with some implementations of the present disclosure;

FIG. 2 is flow diagram showing a method for context-aware video retrieval and inference, in accordance with some implementations of the present disclosure;

FIG. 3 is a system implemented as part of the system of FIG. 1 to process long-form video input and execute agentic inference operations based at least on multimodal query processing, in accordance with some implementations of the present disclosure;

FIG. 4 is a language model input context, in accordance with some implementations of the present disclosure;

FIG. 5A is another example interaction performed by components of the agent system to resolve a natural language query, in accordance with some implementations of the present disclosure;

FIG. 5B is an example interaction performed by components of the agent system to resolve a natural language query, in accordance with some implementations of the present disclosure;

FIG. 6A is a block diagram of an example generative language model system suitable for use in implementing at least some implementations of the present disclosure;

FIG. 6B is a block diagram of an example generative language model that includes a transformer encoder-decoder suitable for use in implementing at least some implementations of the present disclosure;

FIG. 6C is a block diagram of an example generative language model that includes a decoder-only transformer architecture suitable for use in implementing at least some implementations of the present disclosure;

FIG. 7 is a block diagram of an example computing device suitable for use in implementing at least some implementations of the present disclosure; and

FIG. 8 is a block diagram of an example data center suitable for use in implementing at least some implementations of the present disclosure.

### DETAILED DESCRIPTION

Systems and methods are disclosed related to context-aware video retrieval and inference systems. This disclosure relates to systems and methods for context-aware retrieval and query resolution using large language models (LLMs), vision language models (VLMs), and embedding systems for video data (e.g., long-form). For example, systems and methods in accordance with the present disclosure facilitate identifying segments of video corresponding to user queries and generating responses based at least on vision-language outputs and language-based inference. The system can apply a RAG framework in which the LLM determines when to invoke one or more function calls associated with a video model and/or an embedding subsystem. That is, the systems and methods can generate embeddings (e.g., video embeddings, image embeddings, audio embeddings, text embeddings, motion vector embeddings, scene attribute embeddings, transcript embeddings), select models based at least on a domain of a video sequence, apply follow-up queries to a video model, and/or generate answers based at least on model coordination and context data. For example, the various interactions and operations can occur on live video streams or pre-recorded video data. Additionally, the LLM can maintain an agentic role across query execution stages, controlling inference workflows by issuing and interpreting model outputs and updating a working context across queries.

Some traditional approaches rely on deterministic processing systems and/or use manual inspection of video content to identify relevant events. These systems can typically be domain-limited and do not support query-driven summarization and/or interactive question answering, and lack implementations for segmenting and/or analyzing long-duration video data (e.g., 24-hour surveillance footage, continuous sports broadcasts). Other limitations can include static pipeline configurations that do not permit selection of different video models based at least on the domain (e.g., warehouse environment, urban roadway, sports game, smart city intersection, autonomous vehicle test track, robot environment) and the absence of modular coordination between language-based models and video-based models. Some systems can use neural network-based approaches, including language model-based approaches, to identify events, but lack performance (e.g., correctly retrieving relevant videos or video segments) as the length of video increases. Additionally, RAG and agentic coordination between the LLM, VLMs, and/or other components are not implemented in these approaches, preventing dynamic query resolution and context-driven tool invocation. For example, fixed-function systems do not dynamically route user queries to appropriate model components and do not incorporate context data to adapt behavior across query sequences. Such limitations restrict long-form video analysis, prevent intelligent reuse of embeddings and/or inference results, and limit extensibility for workflows or downstream system integration.

Systems and methods described in the present disclosure address these limitations by implementing a modular architecture for applying queries across multimodal data sources, including embeddings and context-driven reasoning. For example, the system can receive a first query corresponding to an event in at least one video sequence and apply one or more embeddings and a second query to a video model to generate an intermediate output. The output can be used as input to a language model to generate a response, where the response can be based at least on context data including a system context, long-term context, and/or short-term context. In some implementations, the system can identify whether a new embedding is required, select a timestamp and duration, and invoke an embedding system (e.g., video intelligence agent) to generate additional embeddings and/or corresponding metadata (e.g., derived representations of the video content, such as text, nodes, edges, and/or community summaries, etc.) from the video data. The additional embeddings and/or the corresponding metadata can be applied to the video model for inference, and outputs can be applied as input to the language model for generation of an output.

In some implementations, the system can select a video model based at least on a domain associated with the video sequence. The system can segment video data into segments and/or chunks based at least on segmentation parameters (e.g., fixed-length duration such as 5 seconds or 20 frames, context-aware segmentation such as scene cut detection, task-specific segmentation such as per play in a sports video, adaptive segmentation, and/or a parameter based at least on the domain) and/or a frame sampling parameter (e.g., uniform frame intervals, adaptive motion-based sampling, frame selection based at least on metrics, and/or any domain-aware frame selection logic), then apply the segments as input to an embedding system to generate a plurality of embeddings (e.g., video embeddings, image embeddings, audio embeddings, text embeddings, motion vector embeddings, scene attribute embeddings, transcript embeddings). An adaptive segmentation (also referred to herein as “smart segmentation”) can be based at least on the amount of detected activity in the video, where the segmentation parameter can vary to increase frame density during high activity periods and decrease frame density during low activity periods. The embeddings can be used to generate metadata (e.g., object label, activity classification, event class, scene context, anomaly indicator, and/or any spatial-temporal tag) using a video model, and/or the metadata can be indexed in a database by identifiers corresponding to embeddings. A graph can be generated based at least on the metadata, with nodes corresponding to labels (e.g., object, action, scene attribute, captions, audio indicators, transcribed words, and/or event class) and edges representing semantic relationships (e.g., temporal proximity, transitions). The system can traverse this graph based at least on a query and identify embeddings corresponding to relevant nodes or edges. In some implementations, the embeddings can be reused in future queries and/or used to trigger notifications and/or external processes.

In some examples, the system can update context data in response to processing events and/or queries (e.g., external from a user, or internal between components). For example, applying input to a video model or embedding system can result in updates to long-term context and processing a sequence of queries can update short-term context. The updates can be stored and accessed via function calls by the various models (e.g., language model, video model). The context data can include tokens, summaries of prior interactions, and/or structured queues of interaction history. The context data can be used by the language model to influence subsequent output. In some implementations, the system configuration allows querying long-form video data and supports interactive and autonomous applications (e.g., real-time or near real-time monitoring, alert triggering, and/or downstream inference). The implementations provide improved system extensibility, video indexing precision, and coordinated interaction between multimodal inference models, graph neural networks, and/or databases or data storages.

The systems and methods described herein can be applied to context-aware video retrieval and query-based summarization using large language models (LLMs), vision-language models (VLMs), and embedding-based indexing, including use cases involving surveillance footage analysis, smart city monitoring, autonomous vehicle event detection, robotic vision systems, and/or edge-based video processing. For example, the system can segment video data based at least on a domain-specific segmentation parameter and generate a plurality of embeddings (e.g., video embeddings, image embeddings, audio embeddings, text embeddings, motion vector embeddings, scene attribute embeddings, transcript embeddings) using an embedding system. The architecture provides technical improvement to multimodal language agents to answer queries and generate responses for long-form video sequences by dynamically selecting embeddings, routing queries to model components, and/or using context data to facilitate inference across multi-turn conversations. The implementations remove and/or reduce dependencies on deterministic pipelines, static metadata extractors, and/or human-in-the-loop inspection and provide improvements in intelligent indexing, query response quality, and/or processing efficiency across variable video domains and temporal ranges.

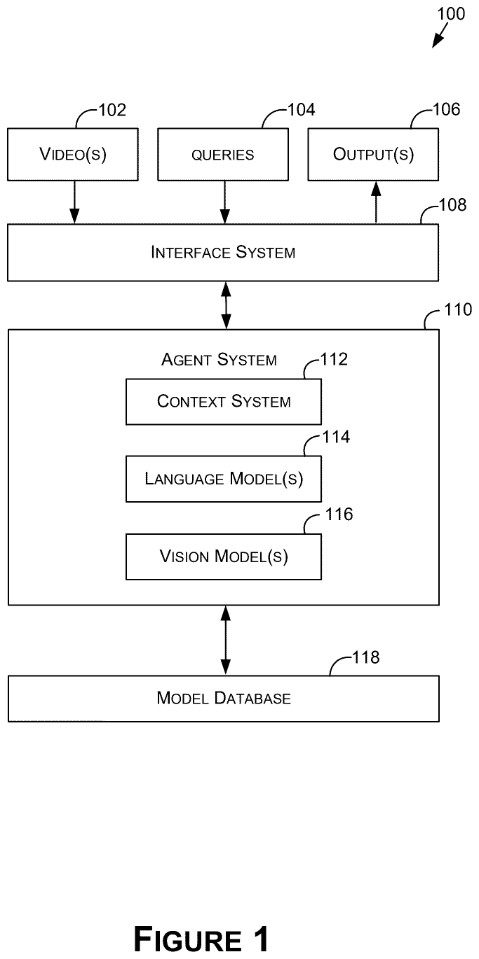

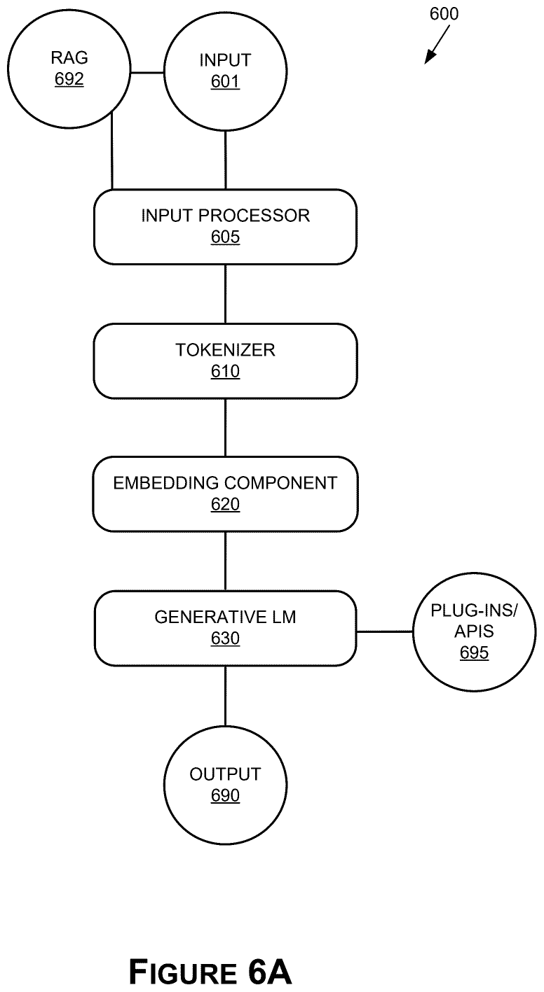

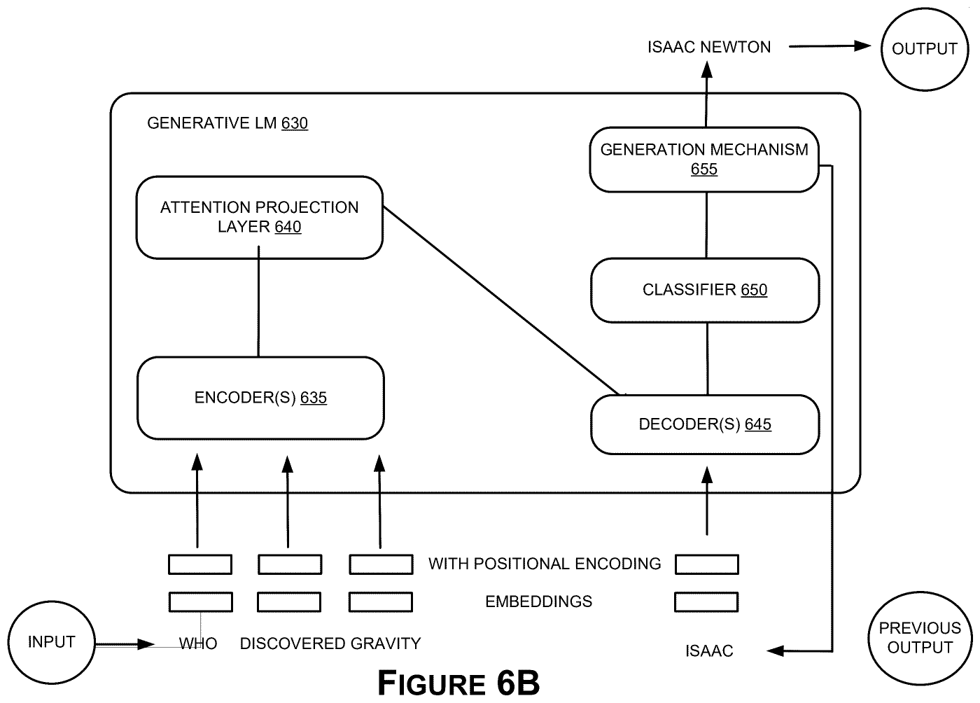

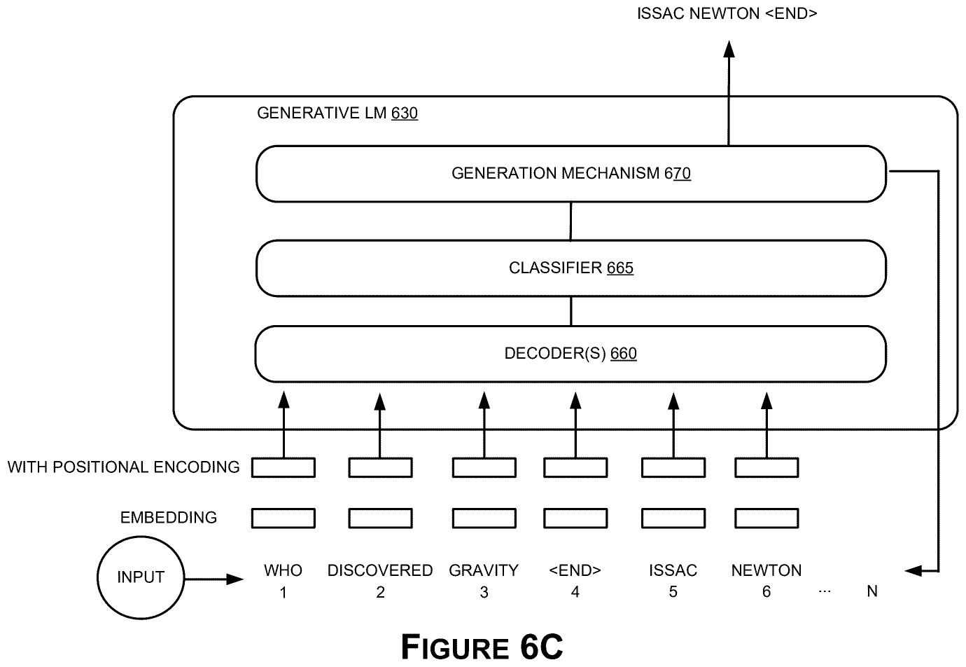

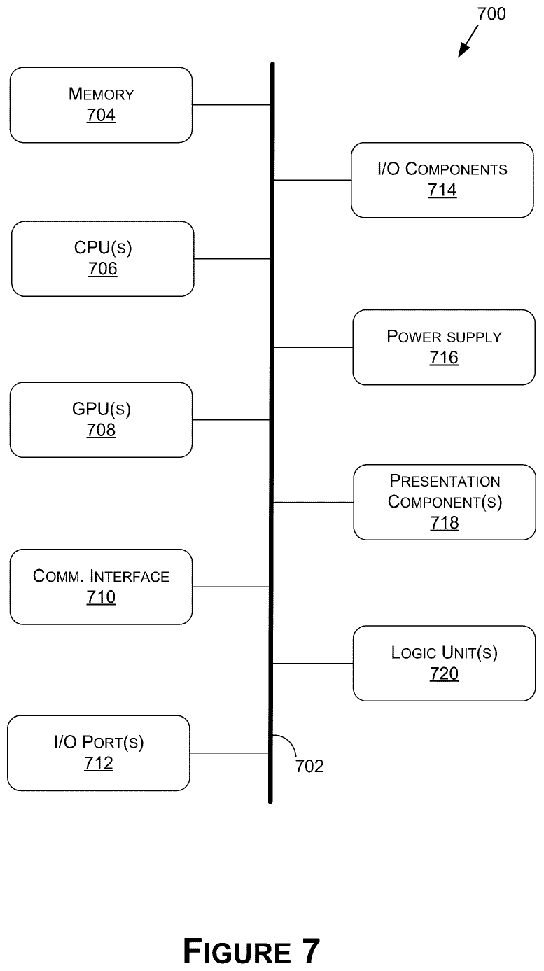

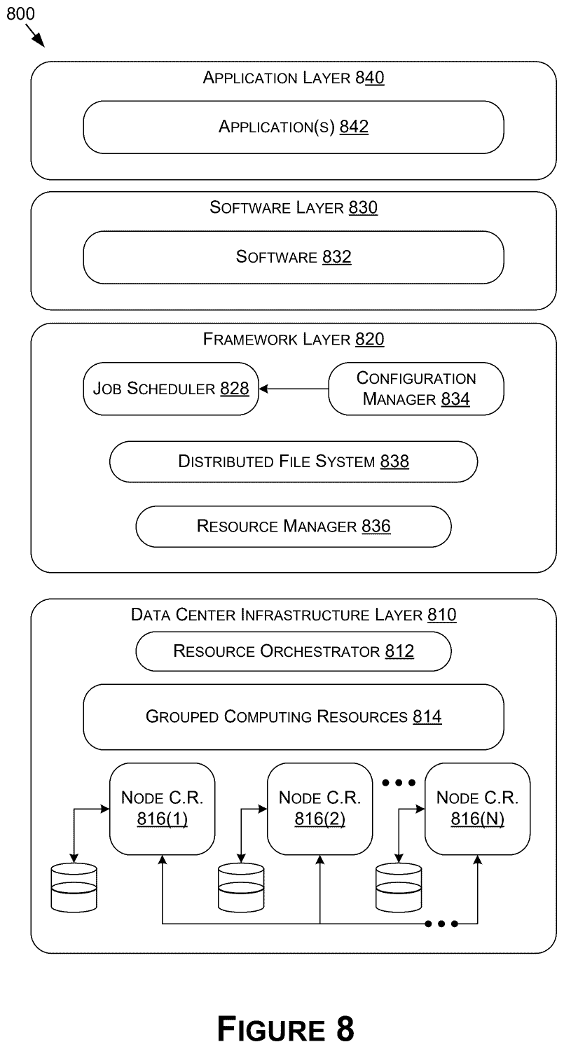

With reference to FIG. 1, FIG. 1 is an example block diagram of system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 6A-6C), one or more computing devices or components thereof (e.g., as described in FIG. 7), and/or one or more data centers or components thereof (e.g., as described in FIG. 8).

The system 100 can implement at least a portion of an agentic pipeline, such as but not limited to a context-aware retrieval pipeline, an embedding-based video reasoning pipeline, and/or a multimodal query resolution pipeline. The system 100 can be used to process video queries and/or generate context-based responses by any of various systems described herein, including but not limited to surveillance analysis systems, smart city monitoring systems, autonomous vehicle event detection systems, robotic vision systems, and/or edge-based video processing systems.

Generally, the agentic pipeline can include operations performed by the system 100. For example, the agentic pipeline can include any one or more of an interfacing stage, an agentic stage, and/or an outputting stage. The agentic stage can include sub-stages including any one or more of an ingestion and embedding (IE) sub-stage, a language modeling sub-stage, a video modeling sub-stage, and/or a caption generation sub-stage. Each stage and/or sub-stage of the agentic pipeline includes one or more components of the system 100 that perform the functions described herein. In some implementations, one or more of the stages can be performed during the training of AI models. Additionally, one or more of the stages can be performed during inference using the AI models.

The system 100 (e.g., implementing the agentic pipeline) can receive, via an interface, a first query (e.g., the queries 104) corresponding to an event in at least one video sequence. In some implementations, the system 100 implementing the agentic pipeline can apply at least one embedding of a plurality of embeddings and a second query corresponding to at least one language model as input to at least one video model to cause the at least one video model to generate a first output corresponding to the second query. Additionally, the system 100 implementing the agentic pipeline can apply the first output as input to the at least one language model to cause the at least one language model to generate a second output corresponding to the first query. For example, the system 100 can generate, using at least one language model, a second output corresponding to the query based at least on context data and the first output. The at least one language model can be trained and/or otherwise implemented to generate the second output based at least on context data. In some implementations, the system 100 implementing the agentic pipeline can provide, via the interface, the second output.

In some implementations, the interfacing stage can be the stage in the agentic pipeline in which the system 100 can receive input data and generate an initial representation of the query. The system 100 can include at least one interface system 108. The interface system 108 can receive, via an interface, a first query (e.g., the queries 104) corresponding to an event in at least one video sequence (e.g., the video(s) 102, such as recording, capture instance, live-stream, media upload, and/or any multimodal input). For example, during interfacing stage the interface system 108 can process a user query and generate an internal request based at least on the query. The first query can be a natural language input, a predefined prompt, a system-generated query, and/or any input derived from metadata or context. For example, the first query can be “when did the person place the box.” In another example, the first query can be “was there an accident near the forklift.” In yet another example, the first query can be “which team scored after the timeout.” The event can be a specific occurrence and/or action (e.g., motion, interaction, temporal segment, activity, object transition, and/or any state change). That is, the event can be associated with a portion of a video sequence representing a condition or activity of interest. In some implementations, the interface system 108 can receive and/or otherwise identify the query by parsing a structured request and/or interpret a free-form query. The interface can be a graphical interface, an API endpoint, a messaging protocol, and/or any input mechanism accessible by a client system (e.g., user device, mobile device, computing system). That is, the interface can provide a communication channel between the system 100 and one or more external systems. For example, the interface system 108 can receive a request over a network and convert it to an internal query format for processing (e.g., generate embeddings, store to be used during inference).

In some implementations, the agentic stage can be the stage in the agentic pipeline in which the system 100 can facilitate model interactions and manage context data for query resolution. The system 100 can include at least one agent system 110. The agent system 110 can include a context system 112, language model(s) 114, and/or video model(s) 116. Various sub-stages can be performed in parallel or in sequence based at least on the query and/or the context state. That is, a sub-stage can be triggered by a model output, a rule-based condition, and/or a follow-up query. It should be understood that sub-stages can be performed repeatedly, conditionally, and/or based at least on dynamic scheduling logic. For example, the language modeling sub-stage of the agentic stage can include the agent system 110 applying one or more inputs (e.g., queries received via the interface system 108, outputs of the video model(s) 116, and/or contexts or other information of the context system 112) to at least one language model 114 to cause the at least one language model 114 to generate an output (e.g., response to the queries 104 by a user, response to an output of the video model(s) 116). In another example, the video modeling sub-stage of the agentic stage can include the agent system 110 applying one or more inputs (e.g., video embeddings and/or other embeddings, outputs of the language model(s) 114, and/or contexts or other information of the context system 112) to at least one video model 116 to cause the at least one video model 116 to generate an output (e.g., response to an output of the language model(s) 114).

In yet another example, the ingestion and embedding (IE) sub-stage of the agentic stage can include the agent system 110 ingesting video data (e.g., the video(s) 102) provided by the user and processing the video(s) 102 to generate a set of structured representations, including transcriptions, caption data, video embeddings, image embeddings, audio embeddings, text embeddings, motion vector embeddings, scene attribute embeddings, transcript embeddings, and/or a graph representation of extracted metadata. In yet another example, the IE sub-stage of the agentic stage can include the agent system 110 generating a plurality of embeddings based at least on a plurality of video segments (e.g., corresponding to a live video stream and/or recorded video data).

Additionally, various contexts (e.g., system context, working context, short-term contexts, such as summaries and queues) can be created, updated, and/or maintained by the context system 112 based at least on the processing and/or executing by the agent system 110. Generally, contexts can be represented as tokens and/or data structures (e.g., queues, key-value stores, summarized message logs, and/or any data buffers used during query processing). System contexts can refer to working contexts that persist across multiple queries and/or sessions. That is, system context can represent persistent memory for storing system data, identifiers, and/or system-level metadata accessible to models (e.g., the language models 114 and/or the video models 116) during inference. Long-term contexts can refer to working contexts that are read-write and contain structured data for agentic processing, such as identifiers of relevant embeddings, activity counters, task-specific variable bindings, and/or any intermediate values used by the language model 114 or video model 116 to coordinate function calls or sub-stage transitions. That is, long-term context can represent memory used to store and retrieve intermediate data necessary for executing language model or video model operations across sub-stages. Short-term contexts can refer to summaries and/or queues that store recent interactions and are subject to message eviction. That is, short-term contexts can represent transient memory used to maintain recent conversational history and/or interaction flow.

In some implementations, the system context can be a set of tokens and associated logic structures that define control flow, model behavior, memory access policies, and/or system roles. For example, the system context can include tokens representing function routing instructions for selecting between multiple models (e.g., vision-language model, video model, audio model) during query resolution. In another example, the system context can include configuration flags indicating whether outputs should be routed to external systems (e.g., user interface) or internal components (e.g., context system, database update handler). In yet another example, the system context can include memory access directives specifying how embeddings or intermediate outputs are referenced across the working context and short-term memory.

The system context can be stored in a memory storage (e.g., local RAM, persistent storage, and/or any distributed memory system). The set of tokens can represent serialized data structures representing variables, identifiers, memory references, model directives, and/or other machine-readable elements interpretable by the language model 114 and/or the video model 116. That is, the tokens can be a representation of structured information used by the language model 114 and/or the video model 116 to reference prior states, access context, and/or guide function execution across processing stages. The system context can include information describing how the system operates (e.g., execution triggered by received messages or periodic polling), how the language model(s) should process and/or respond to inputs, and/or how memory components such as short-term context, working context, and/or video indices are accessed and/or modified. That is, the context system 112 can initialize the system context and provide it to the language model 114 to influence function selection, context interactions, and/or model coordination. For example, the system context can include control tokens indicating available model (e.g., LLM, VLM), memory usage patterns, and/or procedures for storing and retrieving context data. Additionally, the context system 112 can update the system context by registering newly available tools, modifying execution instructions, and/or incorporating configuration updates from external systems.

In some implementations, the working context (e.g., long-term context) can be a set of tokens and associated logic structures that define temporary storage for intermediate values, retrieval outputs, query metadata, and/or model-generated variables during inference. For example, the working context can include embedding identifiers and corresponding timestamps derived from video segment analysis. In another example, the working context can include variables representing intermediate confidence scores or evaluation tags generated by the video model 116. In yet another example, the working context can include references to object labels, event durations, and/or classification outputs stored during earlier inference stages.

The set of tokens can represent serialized data structures representing embedding identifiers, activity counts, timestamps, query-linked values, and/or other transient data used by the language model 114 and/or the video model 116. The working context can be stored in a memory storage (e.g., local RAM, persistent storage, and/or any distributed memory system). That is, the tokens can be representations of working memory used by the language model 114 and/or the video model 116 to store and/or reuse outputs, reference intermediate computations, and/or maintain continuity across multi-step processing sequences. The working context can include information derived from function calls to the video index, short-term memory, and/or other systems (e.g., the video model 116, the model database 118), and can be updated during execution to reflect changes in context or query flow. That is, the context system 112 can update the working context based at least on outputs of the agent system 110 (e.g., the video model 116) and provide the updated context to the language model 114 to influence query handling and dynamic data access. For example, the working context can include token structures indicating retrieved video segments, evaluation states, and/or outputs from the video model 116. Additionally, the context system 112 can update the working context by storing model-generated facts, copying data from short-term memory, and/or appending new entries generated during query execution.

In some implementations, at least one queue (e.g., short-term context) can be a data structure used to maintain a record (e.g., chronological) of interaction messages, including user inputs, assistant outputs, and/or system-level messages. For example, the queue can include user-issued queries referencing specific video sequences, timestamps, and/or requested actions. In another example, the queue can include outputs generated by the language model 114 or video model 116 in response to those queries, such as captions, object detections, and/or temporal event labels. In yet another example, the queue can include internal routing messages identifying model selection.

The at least one queue can be stored in a memory storage (e.g., local RAM, persistent storage, and/or any distributed memory system). The queue can include serialized tokens representing message content, metadata, and/or warnings related to capacity of the agent system 110 and/or memory status. That is, the tokens can be representations of conversational state used by the language model 114 and/or the video model 116 to reference recent exchanges and maintain sequential consistency. The queue can include a fixed-capacity structure (e.g., most recent or last five queries, most recent or last ten queries) managed by a queue manager that evicts older messages when capacity thresholds are reached. That is, the context system 112 can manage the queue as a FIFO (first-in, first-out) buffer to ensure availability of recent dialogue history without exceeding resource constraints. For example, the queue can include tokens indicating user queries, model responses, and internal status updates. Other queue structures, such as LIFO (last-in, first-out), can be used based at least on the implementation. Additionally, the context system 112 can dequeue (e.g., evict) messages from the queue to short-term context and update the summary with a recursive representation of the evicted content.

In some implementations, at least one summary (e.g., short-term context) can be a data structure and/or buffer (e.g., recursive) used to store compressed representations of interaction history previously stored in the queue. For example, the summary can include a chain of event references extracted from evicted dialogue history, such as object transitions or scene changes. In another example, the summary can include derived interpretations or inferred metadata representing user intent over multiple interaction rounds. In yet another example, the summary can include compressed tokens describing interactions involving retrieved video embeddings, associated captions, and/or downstream query outcomes.

The at least one summary can be stored in a memory storage (e.g., local RAM, persistent storage, and/or any distributed memory system). The summary can include serialized tokens representing information extracted from evicted messages (e.g., one or more historical queries), including entity references, query outcomes, inferred relationships, and/or other historical information. That is, the tokens can be representations of aggregated context data used by the language model 114 and/or the video model 116 to recover intent, restore memory, and/or guide follow-up processing when original messages are no longer present in the queue. The summary can be constructed recursively by the context system 112 based at least on evictions from the queue and maintained in parallel with the short-term context. That is, the context system 112 can update the summary as messages are evicted, retaining a compact and query-relevant representation of prior states. For example, the summary can include tokens describing a chain of past questions and their answers. Additionally, the context system 112 can access the summary during inference to restore prior context and influence generation by the language model 114.

Additionally, the context system 112 can allow, retrieve, expose, and/or otherwise make available the system context, the long-term context, and/or the short-term context to the language model 114 and/or video model 116. That is, the context system 112 can facilitate access to context data for use during model execution, function dispatch, and inference coordination. For example, the context system 112 can retrieve, provide, and/or otherwise allow the language model 114 to obtain (e.g., using a retrieval operation) at least one token corresponding to the system context or the long-term context, a summary of one or more historical queries, or a queue of one or more recent queries (e.g., queue size can determine the number of recent queries). In this example, the context system 112 can allow the agent system 110 to populate the working context with retrieved tokens to support multi-step processing and context-aware model outputs.

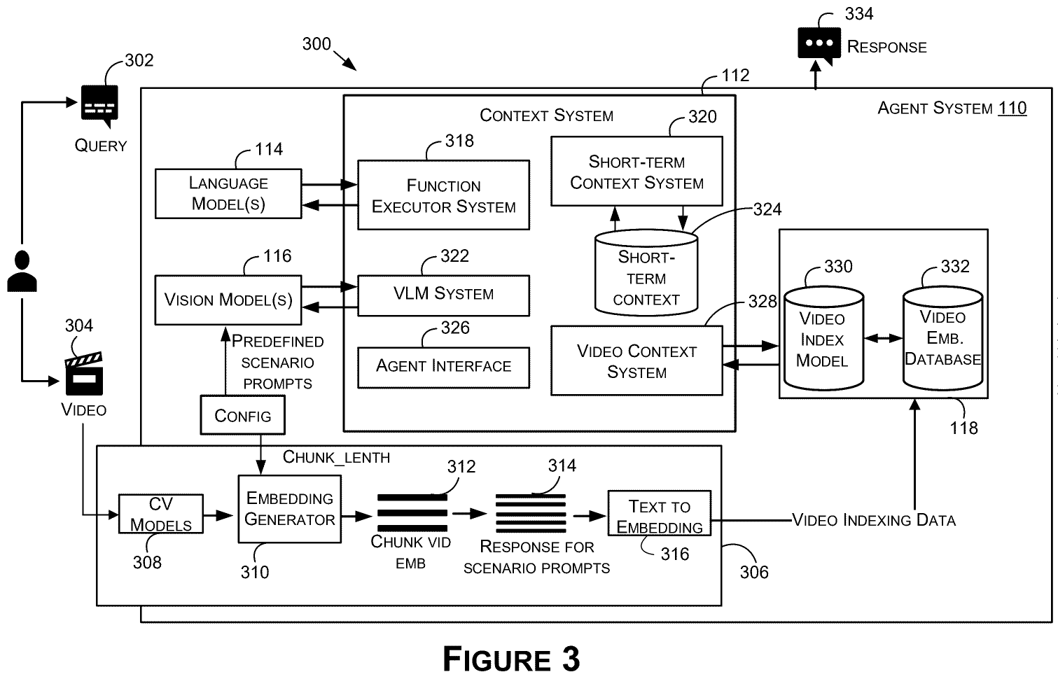

In some implementations, the context system 112 can update context data corresponding to a system context, a long-term context, and/or a short-term context. The context system 112 can update the long-term context (e.g., working context) based at least on applying at least one input to at least one of (i) the at least one language model 114, (ii) the at least one video model 116, or (iii) an embedding system (e.g., the embedding system 306 of FIG. 3). That is, the context system 112 can update the long-term context based at least on outputs generated during model execution, retrieved results, and/or stored facts or video metadata generated by the agent system 110. For example, updating the long-term context can include writing new token entries from model outputs, embedding references, and/or metadata extracted from video sequences. In some implementations, the context system 112 can update the short-term context (e.g., summary and/or queue) based at least on a plurality of queries received (e.g., via the interface system 108). That is, the context system 112 can maintain recent interaction history and trigger enqueue and/or dequeue (and/or pop or poll) procedures based at least on queue capacity and/or interaction flow. For example, updating the short-term context can include enqueueing new messages into the queue, dequeuing older messages when limits are reached, and generating recursive summaries of the evicted content for later retrieval.

In some implementations, the IE sub-stage can be a sub-stage of the agentic stage in the agentic pipeline in which the system 100 can receive and/or otherwise ingest and process the video(s) 102 provided by a user to generate multiple intermediate representations for downstream inference. The agent system 110 (e.g., more particularly, the embedding system 306 of FIG. 3) can obtain the video data (e.g., the video(s) 102) corresponding to at least one user-submitted video sequence. That is, the agent system 110 can access uploaded or referenced video content and perform preprocessing operations including caption generation, transcription, and embedding. For example, during the IE sub-stage, the agent system 110 can identify the video source, decode frames, and/or extract visual and audio features for embedding. In some implementations, the agent system 110 can generate structured outputs including a metadata graph, a plurality of video embeddings and/or other embeddings, and/or a plurality of image embeddings, at least one (e.g., each) corresponding to at least a portion of the input video. The generated outputs can be stored in the model database 118 and indexed for access during inference. For example, the agent system 110 can store the extracted features in association with the video identifier and update the working context for retrieval during later stages.

In some implementations, the IE sub-stage can be a sub-stage of the agentic stage in the agentic pipeline in which the system 100 can retrieve, process, and/or prepare the video(s) 102 for embedding generation. The agent system 110 (e.g., more particularly, the embedding system 306 of FIG. 3) can obtain the video(s) 102 corresponding to the at least one video sequence. That is, the agent system 110 can access live-streamed and/or stored video content for subsequent segmentation and embedding. For example, during the IE sub-stage the agent system 110 can request video content (e.g., responsive to a query) from a data source and buffer it for downstream processing. In some implementations, the agent system 110 can obtain and/or otherwise identify the video(s) 102 from the video sequences by accessing a file path, media stream, and/or network source using an identifier or reference link. The video data can be formatted data corresponding to visual recordings encoded in a supported format. That is, the video data can include image frames, timing data, and/or metadata associated with the source. For example, the agent system 110 can load video from a cloud storage service, internal database, and/or edge device capture buffer.

Generally, the system 100 can model and/or process long-form video content (e.g., videos exceeding several hours or days) by segmenting the video(s) 102 into bounded regions and generating corresponding embeddings (e.g., video embeddings, image embeddings, audio embeddings, text embeddings, motion vector embeddings, scene attribute embeddings, transcript embeddings) stored in the model database 118. The language model 114 and the video model 116 can operate across multiple interactions using structured memory representations to handle disjoint temporal segments without reloading full-length video data. During execution, the language model 114 accesses summary entries and query outputs stored in short-term context and references identifiers and temporal metadata stored in working context to construct follow-up queries. The configuration reduces memory consumption by the language model 114 and facilitates iterative, context-driven traversal of long-form video content using frame-localized embeddings.

Additionally, the system 100 can apply a staged inference architecture across long-duration videos (e.g., video(s) 102) by combining outputs of the video model 116 with structured memory updates. For example, when the video model 116 generates a result indicating missing or incomplete embedding coverage for a query, the language model 114 references working context to identify prior timestamps and durations associated with that query path. A follow-up request can trigger generation of additional embeddings and/or corresponding metadata (e.g., text, nodes, edges, and/or community summaries, etc.) for the uncovered segment, which can be passed to the video model 116 for refinement. The segmented inference architecture facilitates scalable vision-language processing for long-form video, for example, without requiring monolithic model inputs. Additionally, the segmented inference architecture supports retrieval, response generation, and/or temporal navigation across frame regions using memory-efficient operations.

In some implementations, the IE sub-stage can be a sub-stage of the agentic stage in the agentic pipeline in which the system 100 can segment the obtained video data into units for embedding. Additionally, the agent system 110 can preprocess and/or otherwise format the video(s) 102 into a model-compatible representation (e.g., a structured data format including frame sequences, metadata, and/or model-ingestible attributes such as resolution, frame rate, and encoding type). Preprocessing can include decoding video streams, normalizing frame resolutions, and/or removing corrupt or unsupported frames. For example, buffering can include temporarily storing frame batches in memory to align input windows with segmentation parameters and maintain temporal ordering. That is, the system 100 can perform preprocessing by applying decoding, resizing, normalization, and/or frame sampling operations. Formatting can include converting frames into structured feature maps (e.g., tensor arrays) with standardized dimensions, channel configurations, and/or data types. That is, the system 100 can transform video frames into batched model inputs suitable for neural network ingestion, graph generation, inference, and/or any embedding-based downstream operation. For example, converting can include changing color space from YUV to RGB, resizing to a fixed input dimension, and/or reordering frame axes to match model input expectations.

The agent system 110 (e.g., more particularly, the embedding system 306 of FIG. 3) can segment a plurality of frames of video(s) 102 into a plurality of video segments (e.g., video chunks and/or temporal chunks) based at least on one of a segmentation parameter corresponding to a domain of the at least one video sequence and/or a frame sampling parameter. That is, the agent system 110 can segment and/or otherwise chunk video(s) 102 into segments that reflect temporal structure and/or domain-relevant boundaries. For example, during the IE sub-stage the agent system 110 can divide a continuous video stream into overlapping and/or non-overlapping segments based at least on predefined conditions.

In some implementations, the segmentation parameter can be of a fixed-length duration, such as 5 seconds and/or 20 frames, a domain-based threshold, and/or a dynamically computed duration, such as context-aware (e.g., scene boundary detection, e.g., scene cut detection, frame difference thresholding) and/or task-specific (e.g., application-specific heuristics, e.g., per play, per detected event). That is, the agent system 110 can apply rules and/or model-based logic to define where at least one (e.g., each) video segment begins and ends. For example, the agent system 110 can use fixed intervals for regular chunking. In another example, the agent system 110 can use dynamic segmentation when event boundaries are detected. Additionally, the frame sampling parameter can correspond to how frames are selected (e.g., every N frames, keyframes only, based at least on motion, entropy scoring, object activity, and/or any statistical or rule-based sampling). That is, the agent system 110 can select frames from at least one (e.g., each) segment based at least on motion characteristics, uniformity, and/or analysis goals. For example, the agent system 110 can select representative frames using activity thresholds and/or sampling distributions.

In some implementations, the agent system 110 can perform adaptive segmentation based at least on activity levels detected within a video segment. For example, the agent system 110 can increase the sampling rate in segments with high motion or event density and reduce the rate in segments with minimal activity. The dynamic adjustment can improve temporal resolution where needed while reducing redundant data in static scenes.

In some implementations, the agent system 110 can segment and/or otherwise chunk the video(s) 102 by iterating over the video frames to at least one of applying a segmentation parameter to determine temporal boundaries between segments, and/or then applying the frame sampling parameter within each segment to select frames for inclusion based at least on sampling criteria such as fixed intervals, motion metrics, or keyframe detection. That is, the agent system 110 can define segment boundaries using fixed-length durations, domain-based thresholds, and/or dynamically computed durations, and select frames within at least one (e.g., each) segment using motion-based filters, interval rules, or other statistical or rule-based techniques. For example, the agent system 110 can use fixed 5-second windows for segmentation and select every Nth frame within each segment. In this example, the segmentation parameter determines where at least one (e.g., each) segment begins and ends, and the frame sampling parameter determines how frames are selected within that segment for use in embedding generation. The video segments can be a set of grouped frames with associated timing data. That is, the video segments can serve as the input units for generating embeddings tied to visual context. For example, the agent system 110 can submit at least one (e.g., each) segment to the embedding system for downstream vector generation.

In some implementations, the IE sub-stage can be a sub-stage of the agentic stage in the agentic pipeline in which the system 100 can generate vector embeddings representing features of video segments. The vector embeddings can correspond to temporal, spatial, semantic, and/or multimodal features derived from video segments and can include metadata that can be queried from the model database 118. The agent system 110 (e.g., more particularly, the embedding system 306 of FIG. 3) can generate (e.g., using the embedding system 306 and/or any other video intelligence agent (VIA)) the plurality of embeddings based at least on the plurality of video segments. That is, the agent system 110 can apply one or more neural networks to compute latent representations from at least one (e.g., each) segment. For example, during the IE sub-stage the agent system 110 can submit a batch of video segments as preprocessed tensor inputs to a visual encoder (e.g., convolutional and/or transformer-based), extract the final-layer feature vectors, and/or format the outputs as embeddings.

The plurality of video embeddings can include metadata and can correspond to a live video stream and/or recorded video data (e.g., video(s) 102). With regards to a live video stream, the agent system 110 can dynamically segment and process frames as they are received, generating embeddings in near real-time for immediate downstream use. That is, at least one (e.g., each) incoming frame or group of frames from the live feed can be passed to the embedding system 306 to generate a chunk-level embedding and store the result in the model database 118 for subsequent retrieval. For example, as frames are ingested from a live feed, the agent system 110 can trigger chunk creation at fixed intervals (e.g., every 2 seconds), extract features using the CV models 308, and output video embeddings 312 and/or metadata to the video embedding database 332.

The plurality of non-video embeddings can include metadata and can correspond to image inputs, audio data, and/or transcribed text. With regards to image inputs, the agent system 110 can receive image files or extracted keyframes and generate embeddings using the embedding system 306 for storage in the model database 118. That is, at least one (e.g., each) image can be passed through the CV models 308 to produce image embeddings 314 and/or metadata for downstream retrieval. For example, as image data is uploaded or extracted from a video source, the agent system 110 can process the data using feature extraction models to generate structured embeddings for subsequent retrieval. With regards to audio data, the agent system 110 can segment audio tracks into time-bound windows, apply audio analysis models, and/or generate audio embeddings 316 stored in the model database 118. For example, speech segments can be processed to extract speaker, emotion, and/or spectral content. With regards to transcribed text, the agent system 110 can convert audio into text and generate text embeddings using a language model. That is, the non-video embeddings can be queried and used by the language model 114 and/or video model 116 in combination with video embeddings for multimodal inference.

In some implementations, the agent system 110 can generate and/or otherwise create the embeddings by performing per-frame and/or multi-frame feature extraction using a trained vision or vision-language model, and aggregating the resulting features into a vector representation (e.g., via mean pooling, attention-based pooling, and/or temporal fusion). The embeddings can be vectors representing temporal, spatial, semantic, and/or multimodal features (collectively referred to herein as “metadata”) extracted from the input segments. That is, an embedding can encapsulate characteristics of the video segment that are usable by downstream models (e.g., the language model 114 and/or the video model 116) for retrieval, classification, and/or reasoning. For example, the agent system 110 can store the generated embeddings in an index to support similarity search and/or context-aware retrieval. In some implementations, embeddings can be stored in the model database 118 (e.g., in a video embedding data storage and/or database, such as a video embedding database 332 of FIG. 3).

In some implementations, the model database 118 can store embeddings (e.g., generated by the agent system 110), training data used by the language model 114 and/or video model 116, model parameters, context data, graphs of metadata, metadata, and/or any stored representation required for model execution, retrieval coordination, or system interaction tracking configuring the language model 114 and/or video model 116 for inference, training, fine-tuning, and/or any processing stage. The model database 118 can be a persistent storage component (e.g., object store, relational database, NoSQL database) and/or any other memory storage configured to index and/or retrieve data associated with the models and video sequences. For example, the model database 118 can be implemented as a vector database, document store, key-value storage service, and/or any modular backend system supporting access to structured and/or unstructured model data.

The model database 118 can be queried by the agent system 110 and/or components of the agent system 110 (e.g., the context system 112, the language model 114, and/or the video model 116) by issuing query operations based at least on identifiers, semantic similarity, and/or data references associated with video or context elements. That is, the agent system 110 can retrieve data for inference, model operations, and/or embedding lookup using structured access routines. For example, the context system 112 can issue a similarity search query to retrieve embeddings associated with a past event or input, e.g., received by the language model 114. In this example, the similarity search can be executed using a reference embedding generated from the input query and compared against stored embedding vectors to compute a ranked list of candidate matches. In this example, the reference embedding can represent an embedding vector generated by the language model 114 for a query such as “fall incident in warehouse,” and the context system 112 can compare the reference embedding against, for example, a collection of video embeddings stored in the model database 118 (e.g., [vid_emd234], [vid_emd1940], [vid_emd3]) to compute similarity scores and return a ranked list of candidate segments (e.g., [vid_emd1940: 0.92], [vid_emd3: 0.86], [vid_emd234: 0.79]).

In some implementations, similarity search can be performed using cosine similarity, dot product scoring, threshold filtering, and/or any vector distance calculation compatible with the embedding type. The language model 114 can generate search video index requests for the context system 112 to perform a similarity search on a video index (e.g., video embeddings stored in the model database 118). That is, language model 114 can output a function call with a search vector and parameters for filtering and ranking results. The context system 112 can receive the function call, apply the search vector against stored embeddings, and return the identifiers of relevant video segments (e.g., list of embedding identifiers). For example, the context system 112 can return a list of embedding identifiers corresponding to stored segments ranked by similarity. In another example, the context system 112 can return embedding metadata and temporal markers for segment retrieval or subsequent model input.

In some implementations, the IE sub-stage can be a sub-stage of the agentic stage in the agentic pipeline in which the system 100 can construct a graph representation of the metadata extracted from embeddings. For example, the graph can be a neural network graph representing model-inferred associations between semantic concepts, spatial attributes, and/or temporal transitions across video segments. In another, the graph can be a heterogeneous metadata graph representing multi-source embedding outputs, including audio tags, text segments, visual labels, and/or inferred events.

In some implementations, the agent system 110 can generate a graph based at least on metadata. In some implementations, the video model 116 can generate the graph by identifying labels and relationships from video embeddings (e.g., images) and mapping them into a structured graph format. Other systems or components can generate the graph, such as the language model 114 by converting caption data or transcribed queries into labeled nodes and contextual links, or the context system 112 by integrating metadata across embedding types into a unified graph structure. For example, the video model 116 can perform extraction on images by analyzing visual features to infer semantic concepts and relationships for graph construction. In some implementations, the language model 114 can generate the graph by processing captions corresponding to video chunks and inferring semantic entities and relationships, which can be mapped into nodes and edges of a structured graph representation. For example, the language model 114 can perform extraction of the metadata on captions of the chunks by interpreting the textual content to determine semantic structure corresponding to nodes and their associations.

The graph can include a plurality of nodes and a plurality of edges corresponding to a structured representation of metadata relationships. In some implementations, the video model(s) 116 can be trained, deployed, and/or implemented to extract metadata of object trajectories, activity labels, scene descriptors, temporal transitions, and/or interaction events from video embeddings and/or other embeddings. Since the graph can be constructed from metadata across different videos, segments, and inference stages, the system 100 can maintain structured relationships between semantic elements over time. That is, the graph can encode temporal and contextual dependencies to support retrieval and inference.

The plurality of nodes can represent a plurality of labels (e.g., semantic nodes). The plurality of edges can represent a plurality of semantic relationships (e.g., temporal dependencies, non-temporal dependencies, and/or contextual dependencies) between at least two of the plurality of nodes. That is, the metadata of the embeddings can include structured labels such as detected objects, actions, scene attributes, and/or temporal markers used to define the graph nodes and their relationships. For example, at least one (e.g., each) node can correspond to a label extracted from a video segment embedding and/or other embeddings, and/or at least one (e.g., each) edge can define a relationship such as temporal order, co-occurrence, and/or logical dependency between two labels. In this example, the graph facilitates traversal-based retrieval and structured reasoning over the metadata associated with stored embeddings. For example, the graph structure can reduce retrieval latency and improve inference accuracy by allowing the system 100 to resolve semantic relationships through efficient traversal and filtering of contextually linked labels. The graph can be queried in the model database 118 during inference operations performed by the language model 114 and/or video model 116. For example, the video model 116 and/or the context system 112 can retrieve nodes or subgraphs matching the structure of a user query or internal function call. In this example, the language model 114 can use the identified nodes and edges to select relevant embeddings for downstream modeling and/or response generation.

In some implementations, the video model 116 and/or the context system 112 can traverse a graph (e.g., to perform lookup and extraction) based at least on a query by the language model 114 to identify at least one node or at least one edge corresponding to metadata. For example, the metadata can be a label (e.g., a semantic identifier associated with a video segment, such as object, action, event class) of a plurality of labels. In this example, the video model 116 and/or the context system 112 can locate the corresponding node in the graph and retrieve the associated video embedding for analysis. In another example, the metadata can be a semantic relationship (e.g., a connection between labels defined by temporal, spatial, or contextual criteria, such as occurs-before, co-occurs-with, causes) of a plurality of semantic relationships. In this example, the video model 116 can follow one or more edges to identify linked nodes and/or retrieve a sequence of embeddings relevant to the relationship defined in the query.

In some implementations, the video model 116 and/or the context system 112 can identify and/or otherwise retrieve at least one of the plurality of video embeddings corresponding to a detected object, action, scene attribute, and/or event class (e.g., in video(s) 102) represented by the identified at least one node or the identified at least one edge. In some implementations, the video model(s) 116 can be trained, deployed, and/or implemented to extract metadata from embeddings generated across multiple video sequences. That is, the video model 116 can determine the relevant video embeddings to provide as a context window, a list, a ranked subset, and/or any embedding set relevant to a query or reasoning task as input to the language model 114. For example, the video model 116 can extract embeddings associated with segments containing a specific object and submit them for response generation. In this example, the language model 114 can use the selected embeddings to generate a textual output based at least on the semantic and temporal structure of the referenced video content.

In some implementations, the caption generation (CG) sub-stage can be a sub-stage of the agentic stage in the agentic pipeline in which the system 100 can generate textual captions based at least on visual features extracted from input video frames or image data. The agent system 110 (e.g., more particularly, the embedding system 306) can apply a vision-language model (VLM) to process image embeddings and output corresponding captions. That is, the agent system 110 can convert frame-level or segment-level embeddings into token sequences representing semantic descriptions of visual content. For example, the agent system 110 can apply an encoder-decoder architecture in which a visual encoder processes an image embedding and a language decoder generates a corresponding caption. The captions can include textual labels, object relationships, actions, and/or contextual cues, which can be stored as metadata in association with the video or image embedding in the model database 118.

The caption data can be indexed and queried to perform retrieval operations based at least on natural language search input (e.g., word-for-word search and retrieval from images). For example, the agent system 110 can receive a text-based query (e.g., the queries 104) from the interface system 108 and compare the query to stored captions using a semantic similarity function and/or keyword match. That is, the CG sub-stage can support retrieval of image or video segments based at least on descriptive language by aligning the input query (e.g., at least one of the queries 104) to caption metadata. For example, a query such as “person entering a building” can be matched to stored captions, and the corresponding image embeddings can be retrieved from the model database 118 and passed to downstream models for further inference and/or presentation. In some implementations, the system 100 can update or refine stored captions based at least on user feedback or contextual model outputs to improve future retrieval accuracy.

In some implementations, the CG sub-stage can be a sub-stage of the agentic stage in the agentic pipeline in which the system 100 can generate textual descriptions from image or video frame embeddings. For example, the system 100 can use a captioning model to generate sentence-level descriptions based at least on image embeddings derived from sampled video frames. In another example, the CG sub-stage can include generating structured captions aligned to object labels, scene contexts, and/or detected activities extracted by the video model 116. The caption data can be formatted for downstream storage in the model database 118 and can be used to support text-based retrieval during inference.

In some implementations, the language modeling sub-stage can be a sub-stage of the agentic stage in the agentic pipeline in which the system 100 can process a query, interpret contexts, and/or generate follow-up instructions or responses based at least on available context and embeddings. The system 100 can include at least one language model 114. Generally, the language model 114 can be a component of the agent architecture implemented by the agent system 110. That is, the language model 114 can operate as a controller that analyzes input queries and determines which functions and/or data to access to respond to the query. Additionally, the language model 114 can issue structured outputs (e.g., the output(s) 106, such as follow-up queries or function calls) based at least on interactions with context data, the context system 112 (e.g., including interactions with the graph neural networks and/or databases or data storages, such as the model database 118), and/or the video model 116 (e.g., accessing video embeddings and/or graph structures).

In some implementations, the agent system 110 can apply the first query (e.g., the queries 104) as input to the language model 114 to cause the language model 114 to generate the second query corresponding to at least one function to perform. The initial inquiry and/or question (e.g., the queries 104) by the user can be fed as input to the language model 114. The generated second query can be a sub-task and/or system-facing instruction. That is, second query can be at least one instruction corresponding to a function for the context system 112 and/or video model 116 to perform. For example, a function to perform can include retrieving, by the video model 116, video metadata from a graph in the model database 118. In another example, a function to perform can include fetching, by the context system 112 from a memory queue, context data. In yet another example, a function to perform can include retrieving, by the video model 116, video embeddings corresponding to a semantic label or relationship from a previously indexed set.

Additionally, the second query can be generated based at least on context data. That is, the language model 114 can use tokens, summaries, and/or queue entries stored in the working context, short-term context, or system context to inform function selection, generate follow-up instructions, and/or maintain state alignment across query resolution steps. For example, the language model 114 can reference previously retrieved embeddings to avoid redundant function calls. In another example, the language model 114 can analyze historical queries in the memory queue to maintain continuity across multi-turn interaction sequences.

The language model 114 can consume intermediate results from the video model 116 (e.g., metadata, graph traversal results, and/or retrieved embeddings) and incorporate the results into a final output resolution step (e.g., as the output(s) 106). The output(s) of the video model 116 can be used by the language model 114 to respond (e.g., via the interface system 108 using the output(s) 106) to the original query (e.g., a query of the queries 104) of the user and/or follow-up query. That is, the interface system 108 can format and transmit the response generated by the language model 114 based at least one video model outputs. For example, the language model 114 can convert a sequence of embeddings representing detected actions into a natural language summary of the event timeline. In this example, the output(s) 106 can be routed via the interface system 108 to a user device and/or stored by the system 100 for downstream use in subsequent queries or application workflows.

Additionally, the at least one language model 114 can be configured (e.g., implemented, trained, updated) to generate the second output (e.g., the output(s) 106) based at least on context data. For example, the at least one language model 114 can generate a second output corresponding to the query based at least on context data and the first output. That is, the language model 114 can use tokens, prior interactions, and/or stored references in the system context, short-term context, or working context to generate outputs that reflect the current and prior states of the interaction. For example, the language model 114 can reference previous instructions it issued to determine whether new outputs are required. In another example, the language model 114 can combine retrieved metadata with stored context to answer a compound or multi-turn question. Additionally, the output(s) 106 can include natural language responses, structured metadata, or task-specific results formatted for user interaction or downstream consumption. That is, the output(s) 106 can represent a final resolution based at least on multimodal inputs and contextual alignment across prior interactions. In some implementations, the language model 114 can generate the output(s) 106 using retrieval-augmented generation based at least on stored embeddings, graph data, and conversation history. In some implementations, the language model 114 can be a generative pre-trained transform (GPT) trained and/or implemented to generate the output(s) 106 (e.g., external) and/or other outputs (e.g., internal) for internal components and/or external systems of system 100. Internal components can include the video model 116 and/or the context system 112, where the output(s) can include follow-up prompts, label selections, task directives, or graph traversal queries used to guide continued inference and/or retrieval. External systems can include a user device operated by a user, where the output(s) 106 can include natural language responses, caption text, structured metadata, and/or action recommendations responsive to a received query (e.g., the queries 104).

In some implementations, the language model 114 can facilitate similarity searches by generating embedding-based search instructions from the input query (e.g., the queries 104) and the current context. That is, the language model 114 can output a structured function call (e.g., search_video_embeddings (“fall,” threshold=0.85)) that references a semantic concept and optional parameters. The function call can be transmitted to the context system 112. The context system 112 can perform the embedding comparison using stored video embeddings in the model database 118. The language model 114 can generate the search instruction by interpreting the query of the user and evaluating available context tokens, such as previously used embedding identifiers, video segment timestamps, and/or task-specific labels. For example, the language model 114 can issue a function call to retrieve embeddings related to prior activity in a warehouse setting when the working context includes a label such as location: warehouse. In another example, the language model 114 can reference the short-term context to determine whether similar queries have already been issued, avoiding redundant searches and/or improving inference. The retrieved embedding identifiers can then be included as part of a second query directed to the video model 116, which uses the selected embeddings to perform inference corresponding to the query of the user.

In some implementations, the video modeling sub-stage can be a sub-stage of the agentic stage in the agentic pipeline in which the system 100 can evaluate video embeddings using at least one video model to generate metadata, labels, other captions, graphs (e.g., nodes and entities) or other outputs associated with video content (e.g., video(s) 102). The system 100 can include at least one video model 116. Generally, the video model 116 can be a component of the agent architecture implemented by the agent system 110. That is, the video model 116 can operate as a downstream model that receives queries and embeddings and performs domain-specific inference. Additionally, the video model 116 can process inputs generated by the language model 114 or selected by the context system 112 to generate structured outputs used for graph construction, metadata indexing, or language generation.

In some implementations, the agent system 110 can apply at least one video embedding (e.g., vid_emdN) of a plurality of video embeddings (e.g., represented by short video segments and/or previously generated and stored in the model database 118) and a second query (e.g., LLM generated query that is task-specific, such as [“Did a person fall?”, vid_emd0]) corresponding to the language model 114 as input to the video model 116 to cause the video model 116 to generate a first output corresponding to the second query. That is, a similarity search can be performed by the context system 112 in advance of the query by the language model 114 to identify relevant embedding identifiers (e.g., a list of video embedding identifiers, such as vid_emd0, vid_emd15, vid_emd22, vid_emd56 corresponding to video segments stored in the model database 118 that are semantically related to the initial LLM query based at least on caption or event descriptions). For example, the similarity search can be provided by the language model 114 indicating a search for video indexes with “accidents.” The context system 112 can perform the similarity search on the video index stored in the model database 118 to return a list of video embedding identifiers to be used by the language model 114 to direct the video model 116. The embeddings can be obtained by querying the model database 118 using embedding identifiers, label references, and/or semantic similarity operations. The model database 118 can return one or more stored embeddings and associated metadata for downstream model input.

In some implementations, the video model 116 can receive the video embedding identifiers (e.g., vid_emd0, vid_emd15) selected by the language model 114 and apply the corresponding video embeddings as input to perform model-based inference. That is, the context system 112 can first retrieve the raw embedding vectors and associated metadata from the model database 118 using the identifiers and provide the retrieved data to the video model 116. The video model 116 can then apply the embedding vectors to its internal processing stack, such as convolutional blocks, temporal attention layers, and/or transformer-based decoding system. For example, the embedding vid_emd15 can be used as input to a task head of the video model 116 implemented to generate a binary classification output (e.g., indicating whether a person is present in the segment). In another example, multiple video embeddings can be stacked or concatenated to form a temporal window for inferring activity sequences over time (e.g., analyzing vid_emd0 to vid_emd5 for continuous fall detection). In yet another example, the video model 116 can include cross-attention systems that compare the retrieved embeddings against auxiliary tokens representing task objectives, such as action labels and/or object classes. The output generated from the analysis can include structured metadata (e.g., event tags, timestamps, object counts) used by the agent system 110 for downstream response construction or follow-up reasoning (e.g., by the language model 114).

In some implementations, applying the video embedding can include providing the embedding (e.g., corresponding with the embedding identifier) along with the query to a selected video model for inference execution. That is, the video model 116 can evaluate the embedding in the context of the query and generate a task-specific output such as a caption, event classification, and/or object detection result. For example, obtaining and/or identifying the video embeddings can include filtering based at least on prior context, node labels in a graph, and/or embedding relevance scores. In this example, applying can include the video model 116 executing an inference pass over the input embedding and generating structured output usable by the language model 114 and/or context system 112. In some implementations, data inputs (e.g., outputs by the language model 114, video embedding identifiers, and/or context data) can be provided as input to a selected video model for inference. The first output can be a caption, label, and/or description corresponding to at least one video embedding. The first output can be generated responsive to a query by the language model 114.

In some implementations, the second query (e.g., the query of the language model 114) can be a function instruction referencing a specific embedding (e.g., vid_emd15), label (e.g., “accident,” “fall,” “robot collision”), and/or task (e.g., “validate occurrence,” “extract object interaction “classify event type”) to be executed by the video model 116. That is, the second query can represent a request to generate metadata, validate a condition, or extract a response associated with a previously stored or retrieved video embedding. For example, the query can instruct the video model 116 to determine whether a specific action occurred in a segment or whether two objects appear simultaneously. In another example, the query can request extraction of a temporal label or classification result associated with a semantic node. Additionally, the output of the video model 116 can be provided to the language model 114 or stored in the working context for further reasoning. That is, the output can represent intermediate inference data used for downstream language generation or result composition. For example, the output can be a structured label that the language model 114 uses to answer a natural language query. In another example, the output can be logged to a metadata graph for future traversal or reuse.

Additionally, the video model 116 can apply at least one of (i) the plurality of embeddings, (ii) at least one caption, (iii) at least a portion of a graph as input to perform model-based inference. That is, the context system 112 can first retrieve the caption data and/or graph structure from the model database 118 using corresponding identifiers and provide the retrieved data to the video model 116. The video model 116 can then apply the caption tokens and/or graph nodes to its internal processing stack, such as transformer blocks, cross-modal attention layers, and/or graph neural network components. For example, the caption “a person enters the room” can be tokenized and applied alongside embedding vid_emd15 to update semantic interpretation. In another example, graph nodes representing “object: door” and “action: open” can be used to inform sequence-level predictions across a video segment.

In some implementations, applying at least one of the plurality of embeddings, at least one caption, and/or at least a portion of a graph can include providing the input data to a selected video model for inference execution. That is, the video model 116 can evaluate the inputs in combination with a query to generate a task-specific output such as an action classification, region of interest, or semantic alignment score. For example, obtaining and/or identifying the caption or graph input can include retrieving caption tokens, node labels, edge data, and/or other metadata associated with video content. In this example, applying can include the video model 116 executing an inference pass using caption features, graph structure, and/or embedding vectors to generate structured outputs usable by the language model 114 and/or context system 112. In some implementations, data inputs (e.g., graph-based substructures, caption text, and/or selected embeddings) can be used as contextual input to guide inference. The first output can include labels, object references, and/or scores corresponding to at least one retrieved data type. The first output can be generated responsive to a query (e.g., the queries 104) by the language model 114.

In some implementations, the agent system 110 can apply a query corresponding to the language model 114 as input to the video model 116 to cause the video model 116 to generate a third output corresponding to the query. The third output can indicate the video model 116 does not have enough information (e.g., embeddings do not contain the information to respond, no relevant label was identified, and/or insufficient scene coverage was detected). That is, when not enough information is available for the video model 116, the agent system 110 can be used in real-time (or near real-time) to obtain the relevant video embedding. In some implementations, the language model 114 can receive the third output (e.g., indicating not enough information) and identify a timestamp and a duration based at least on the third output and the context data. That is, the language model 114 can apply one or more selection rules to determine a temporal window of interest for additional inference. For example, the language model 114 can identify a portion of the video containing partial or incomplete results based at least on prior function calls.

Additionally, the agent system 110 can obtain, using an embedding system (e.g., embedding system 306), at least one additional video embedding based at least on the timestamp (e.g., a start time corresponding to the missing or incomplete information) and the duration (e.g., a time window for generating embeddings covering that start time). In some implementations, the agent system 110 can identify or obtain the video(s) 102, segment a portion of the frames, and/or generate additional video embeddings. In some implementations, the agent system 110 can generate additional video embeddings (e.g., without obtaining the video data and/or perform segmenting) when the video(s) 102 are already stored locally, and sampling parameters are available from prior processing.

In some implementations, obtaining the additional video embeddings based at least on the timestamp can include accessing and/or chunking a video segment corresponding to the temporal region beginning at the timestamp. For example, the timestamp can identify the start of a clip aligned with frame-level metadata generated by earlier processing stages. Additionally, obtaining the additional video embeddings based at least on the duration can include sampling, chunking, and/or segmenting the frames within the specified time window for embedding generation. For example, the duration can correspond to the number of frames used to generate one or more complete chunks of videos for embedding inference. In both examples, the timestamp and the duration can be used in combination by the agent system 110 to select a video segment for embedding based at least on the missing information referenced in the third output. That is, the combination can be used to construct additional video inputs for the agent system 110 based at least on temporal gaps identified by the language model 114.

In some implementations, the agent system 110 can apply at least one of an additional video embedding (e.g., recently generated), a follow-up query (e.g., a task-specific instruction derived from the original query) corresponding to the language model 114, and/or corresponding metadata as input to the video model 116 to cause the video model 116 to generate a fourth output corresponding to the follow-up query. That is, the video model 116 can process the updated embeddings to generate a new result corresponding to the instruction. For example, the fourth output can include a label, event type, and/or scene description relevant to the additional embedding and/or the corresponding metadata.

The agent system 110 can include any one or more artificial intelligence models (e.g., the language model(s) 114 and/or video model(s) 116, such as machine learning models, supervised models, neural network models, deep neural network models), rules, heuristics, algorithms, functions, or various combinations thereof to perform operations including query analysis, embedding evaluation, video segment processing, label prediction, graph-based reasoning, and/or response generation, such as interpreting user input, selecting relevant embeddings, issuing follow-up queries, and/or generating structured outputs (e.g., via the interface system 108 using the output(s) 106). That is, model components of the agent system 110 can be neural networks and/or machine-learning (ML) models trained to perform language inference, video content evaluation, and/or retrieval-augmented processing based at least on multimodal input. In some implementations, the agent system 110 can output semantic labels, text responses, attention maps, metadata, and/or graph structures (e.g., captions, event descriptions, node relationships, video timestamps, and/or any intermediate outputs usable across inference stages). For example, the output can be a natural language response that incorporates metadata from one or more video embeddings. In another example, the output can be a temporal label linked to a detected activity. In some implementations, the video embeddings, task-specific instructions, and/or context tokens can be provided to the agent system 110 to perform combined inference operations across the language model 114 and video model 116.

In some implementations, the agent system 110 can maintain, execute, train, update, and/or otherwise process, refile, or apply one or more artificial intelligence (AI) models during the agentic stage. In some implementations, the AI model(s) can include any type of multimodal or task-oriented AI model capable of generating the outputs 106 based at least on video and/or text input (e.g., semantic inference, contextual classification) to support retrieval, analysis, and/or downstream transformation. For example, the AI model(s) can be trained and/or updated to interpret scene content, issue task-specific queries, and/or extract structured labels, among other multimodal operations. The AI model(s) can be or include a transformer-based model (e.g., a generative pre-trained transformer (GPT) model, a bidirectional encoder representations from transformers (BERT)). The machine-learning model(s) can be or include a convolutional, recurrent, and/or attention-based model, in some implementations. The agent system 110 can execute the AI model to generate the outputs 106 and/or intermediate outputs. The agent system 110 can receive data to provide as input to the AI model(s), which can include video embeddings, graph structures, queries, context tokens, and/or any intermediate state data from prior stages.

In some implementations, the agent system 110 can execute one or more AI models (e.g., the language model 114 and/or the video model 116) by utilizing a modeling framework to improve the performance of the AI model during the agentic stage. The framework can include implementing techniques such as gradient descent, backpropagation, and distributed training to improve across multimodal datasets. The AI model(s) can incorporate mechanisms such as dropout regularization and weight pruning to maintain efficiency and prevent overfitting. For example, during execution, the agent system 110 can partition input data into mini-batches, apply loss functions, and update model parameters iteratively. The AI models can support inference operations that include processing feature vectors, transforming raw input data, and generating probabilistic predictions and/or metrics. The agent system 110 can integrate hardware accelerators such as GPUs or TPUs to handle real-time (or near real-time) or batch-mode computation demands, for example when evaluating long-form video queries or generating large-scale embedding representations.

In some implementations, the agent system 110 can evaluate trained models using various metrics (e.g., precision, recall, and/or F1 score) and/or any domain-aligned evaluation criteria to determine readiness for deployment and/or inference operations. The evaluation can include analyzing model performance on validation datasets, testing datasets, or real-world data inputs to assess consistency and robustness. For example, the agent system 110 can compare model predictions against ground truth data to determine accuracy metrics, error rates, and/or confidence intervals. In another example, the agent system 110 can track performance variations over multiple evaluation cycles to identify potential degradation and/or drift in model accuracy. The evaluation can include the agent system 110 applying techniques such as cross-validation, Monte Carlo simulations, and/or adversarial testing to measure resilience against noise or distributional shifts. In some implementations, the agent system 110 can generate performance metrics and/or data structures including metric values, confusion matrices, and/or calibration plots to identify model effectiveness. The performance metrics and/or data structures can be used to facilitate retraining procedures, model adjustments, and/or fine-tuning processes if evaluation criteria are not met. The agent system 110 can integrate threshold-based criteria, such as enforcing an F1 score above a predefined value, before permitting the language model 114 or video model 116 to be deployed for inference. In some implementations, model evaluation can include automated testing pipelines that perform predefined test cases, analyze false positive and false negative rates, and/or apply statistical significance tests to validate improvements.

In some implementations, the agent system 110 can include at least one AI model (e.g., the language model 114 and/or the video model 116). The model can include an input layer, an output layer, and/or one or more intermediate layers, such as hidden layers, which can each have respective nodes. That is, the model can be defined by a layer-wise architecture implemented to propagate and transform data through a set of learned parameters. For example, the input layer can receive query data, video embeddings, and/or context tokens. For example, the output layer can be textual responses, class labels, and/or semantic tags. For example, the intermediate layers can perform feature extraction, attention computation, and/or sequence modeling.

In some implementations, the system 100 can configure (e.g., train, update, fine-tune, apply transfer learning to) the model by modifying or updating one or more parameters, such as weights and/or biases, of various nodes of the model responsive to evaluating estimated outputs of the model (e.g., generated in response to receiving training examples in a training dataset, such as a training dataset including annotated queries, video-label pairs, and/or event classification ground truth). The agent system 110 can be or include various neural network models, including models that can operate on or generate data including but not limited to natural language tokens, spatial-temporal features, object trajectories, and/or various combinations thereof.

In some implementations, the agent system 110 can be configured (e.g., trained, updated, fine-tuned, has transfer learning performed, etc.) based at least on the training data of the at least one training dataset (e.g., video-caption pairs, query-response logs, and/or synthetic simulation traces). For example, one or more example labels and/or context tokens of the training data can be applied (e.g., by the system 100 and/or in a pre-training and/or tuning process performed by the system 100 or another system) as input to the agent system 110 to cause the agent system 110 to generate an estimated output. The estimated output can be evaluated and/or compared with a known label (or ground truth output) of the training data that correspond with the one or more example queries and/or segments, and the model of the agent system 110 can be updated based at least on the prediction error and/or loss value. For example, based at least on an output of scene classification, one or more parameters (e.g., weights and/or biases) of the model of the agent system 110 can be updated.

In some implementations, the agent system 110 can implement and/or otherwise facilitate a pre-training in which a model is trained on large-scale, unstructured datasets to learn foundational representations (e.g., token-level embeddings, image-level features, and/or graph-based metadata structures). The pre-training can include self-supervised learning techniques such as masked token prediction, next-token prediction, contrastive learning, and/or denoising objectives to develop generalized feature representations. For example, the model can be exposed to large corpora of textual queries, annotated video segments, and/or synthetic logs to extract statistical patterns, semantic relationships, and/or latent structures. In another example, the model can apply unsupervised clustering techniques to identify recurrent patterns and correlations in the training data (e.g., activity clusters, scene transitions, object co-occurrence and/or any domain-specific grouping). The pre-training phase can include updating model parameters based at least on loss functions computed from predicting missing or corrupted data points. The agent system 110 can apply distributed training techniques, including data parallelism, model parallelism, and/or pipeline parallelism, to optimize the computational efficiency of pre-training. The output (e.g., pretrained weights, intermediate embeddings, and/or indexed representations) of the pre-training phase can be used to initialize the model for subsequent fine-tuning on domain-specific tasks.

In some implementations, the agent system 110 can implement and/or otherwise facilitate fine-tuning in which a model is updated to specific tasks (e.g., activity recognition, video captioning, and/or semantic labeling) using domain-specific training datasets (e.g., sports footage, warehouse operations video, and/or autonomous driving logs). The fine-tuning process can include supervised learning, reinforcement learning, and/or contrastive learning to refine the pre-trained representations. For example, the agent system 110 can update parameters to improve model accuracy on event and/or object detection queries. The agent system 110 can update the model by adjusting weights, biases, and/or layer-specific parameters based at least on task-specific loss functions. For example, fine-tuning can include backpropagation-based updates using labeled datasets where the model can be trained to minimize and/or reduce classification errors, prediction uncertainties, and/or inference inconsistencies. In some implementations, fine-tuning can be performed using techniques such as low-rank adaptation (LoRA), adapter layers, and/or selective parameter freezing to reduce computational costs while preserving generalization capabilities. The agent system 110 can iteratively evaluate the model on validation datasets (e.g., user query logs, scenario-specific video sets, and/or internal benchmarks) to track performance changes, mitigate overfitting, and/or determine convergence criteria. Fine-tuning outputs can be evaluated against reference benchmarks (e.g., query resolution latency, embedding precision, and/or output consistency) to assess task alignment, efficiency improvements, and/or robustness against adversarial inputs.

In some implementations, the agent system 110 can implement and/or otherwise facilitate retrieval-augmented generation (RAG) models to improve output quality of the language model 114 and/or the video model 116 by incorporating external knowledge sources. The RAG architecture can include a retrieval system and a generation system, where the retrieval system of agent system 110 can fetch relevant documents, embeddings, or structured data (e.g., captions, graph nodes, metadata vectors, and/or any contextual output) from knowledge bases (e.g., video embedding stores, label graphs, memory queues, and/or any indexed database), and the generation system of agent system 110 can synthesize responses using retrieved content. The agent system 110 can utilize vector search techniques such as FAISS, approximate nearest neighbor (ANN) search, and/or BM25 ranking to identify relevant retrieval candidates. For example, the language model 114 can retrieve contextually relevant passages (e.g., temporal segments, structured labels, and/or recent interaction summaries) from an indexed database and use the retrieved content as additional input for generating responses. In some implementations, the agent system 110 can dynamically update retrieval parameters based at least on query complexity, information density, and/or response ambiguity. The retrieval process can be reinforced using feedback mechanisms, where low-confidence generations trigger additional retrieval iterations. The agent system 110 can integrate hybrid approaches that combine parametric memory from models with non-parametric retrieval sources to balance computational efficiency and factual accuracy.

In some implementations, the agent system 110 can implement and/or otherwise facilitate a sparse expert-based model architecture. The model can utilize a Mixture of Experts (MoE) framework, where a subset of expert networks can be dynamically activated per inference step based at least on input characteristics. For example, when a query requiring both video interpretation and text synthesis is received the agent system 110 can route the input to both domain-specific video experts and general-purpose language experts. The MoE structure can include multiple specialized sub-networks, at least one (e.g., each) trained on different aspects of data processing, and a gating mechanism that selects the relevant experts for a given query. In some implementations, the agent system 110 can include optimizations such as multi-head latent attention, which reduces memory overhead by compressing and reconstructing key-value pairs dynamically, minimizing cache storage requirements during inference. The model can integrate both local and global attention mechanisms, where local attention can process immediate token relationships and global attention can capture long-range dependencies. Additionally, the model can implement soft token merging to reduce redundant input tokens and dynamic token inflation to restore details during later processing stages. The agent system 110 can further improve inference performance by employing hardware acceleration techniques, including tensor parallelism and/or memory-efficient caching strategies. The system 100 can execute the sparse expert-based model architecture (e.g., language model 114 and/or video model 116) for natural language processing, reasoning-based tasks, structured data transformation, and/or multimodal data generation.

In some implementations, the system 100 can apply a multimodal query handling process in which the agent system 110 identifies both caption data and image embeddings corresponding to a user query. That is, the language model 114 can determine that caption-based information stored in the model database 118 does not satisfy a query threshold, and instead generate a query including at least one image identifier. The agent system 110 can retrieve image embeddings (e.g., associated with video frames) and associated caption tokens and apply both as input to the language model 114 to generate a second output (e.g., the output(s) 106) corresponding to the query. In some implementations, the system 100 can perform multiple retrieval iterations to obtain input data for inference. For example, the agent system 110 can retrieve a first video segment based at least on a semantic similarity score from a caption, then a second video segment based at least on image-level embeddings. In another example, the system 100 can rank candidate segments based at least on confidence scores and dynamically select the appropriate modality (e.g., caption, image, or both) for further query handling and/or processing.

In some implementations, the system 100 can improve video search performance for long-form content by storing frame-level image embeddings and associating them with caption tokens and metadata in the model database 118. That is, the agent system 110 can segment sampled frames and apply a vision-language model to generate image embeddings that can be indexed and stored with the corresponding video time ranges. The language model 114 can generate a query plan specifying whether caption data, image data, or both are to be retrieved. In some implementations, the query plan can be based at least on context data (e.g., short-term summaries or working context tokens) indicating low-confidence caption outputs and/or prior retrieval failures. The system 100 can traverse the graph structure to identify relevant image embeddings and apply the embeddings as input to the video model 116. In examples where image-level retrieval is used, the system 100 can perform multiple iterations of caption and image retrieval using updated query formulations and/or updated segment boundaries to refine the output.

In some implementations, the agent system 110 can perform retrieval operations using computer vision metadata stored in the model database 118. That is, video metadata generated by the video model 116 (e.g., activity labels, object attributes, counts, timestamps, and/or other scene-level descriptors) can be stored as structured entries associated with at least one (e.g., each) video embedding. The language model 114 can generate a retrieval query specifying a metadata condition (e.g., people_count greater than or equal to 5) and transmit the query to the video model 116 to retrieve a subset of candidate video segments. The agent system 110 can then apply the retrieved metadata and/or embeddings as input to the video model 116 for further analysis. For example, the video model 116 can determine whether visual information is needed to complete the query. In another example, the video model 116 can output a label or caption responsive to the condition-matched segment. In some implementations, the metadata condition can be generated based at least on parsed elements of the initial user query, context data stored in the short-term context, and/or prior retrieval results.

In some implementations, the system 100 can associate computer vision metadata generated from sampled video frames with corresponding caption and embedding entries, and/or store the combined data in the model database 118 for later retrieval. The agent system 110 can apply metadata-based filters to narrow the candidate segment set in response to a query. That is, the language model 114 can generate a query specifying one or more constraints (e.g., detected object count, timestamp range, and/or attribute match), which can be used to select video segments indexed by the metadata values. In long-form video use cases, metadata-based filtering can reduce the number of irrelevant segments retrieved and/or reduce query latency. For example, a condition-based filter can retrieve the segments tagged with people_count values greater than a threshold and within a specified timestamp window. The system 100 can then apply additional query refinement using the filtered embeddings and/or captions as input to the video model 116.

In some implementations, the system 100 can apply hierarchical clustering of content into community-level summary nodes (e.g., stored in the model database 118) to reduce retrieval complexity and improve semantic relevance in long-form video content processing. The agent system 110 can segment video-derived data into groups of temporally consecutive chunks and apply the language model 114 and/or the video model 116 to generate a community summary for each group. The summaries can be indexed as abstract nodes in the graph-based structure maintained in the model database 118 and linked to their originating chunk identifiers. During query execution, the agent system 110 can initiate top-level retrieval using the community summaries to narrow the search space. Once a relevant community is identified, the system 100 can reference linked video embeddings and chunk summaries for refinement. The layered representation improves the precision of retrieval operations by reducing reliance on isolated chunk matching and supports scalable search across long-duration video sequences with abstracted semantic alignment. In some implementations, the community summaries can also be used to perform summarization tasks by extracting representative descriptions from each group. Additionally, the indexed summaries can support retrieval operations by matching natural language queries to high-level semantic groupings before retrieving specific segments.

In some implementations, the agent system 110 can generate a set of intermediate summaries based at least on temporal groupings of video embeddings and caption data. The agent system 110 can segment video data into consecutive chunk groups (e.g., fixed-size or context-derived) and apply the language model 114 to generate a summary node for at least one (e.g., each) group. The summary nodes can be added to a graph structure (e.g., stored in the model database 118) and linked to constituent chunks using graph edges representing group membership and/or temporal order. During inference, the language model 114 and/or the video model 116 can query the graph to identify a summary node representing a relevant video segment. In some implementations, the summary nodes can be traversed first to reduce the number of direct chunk comparisons. For example, the agent system 110 can retrieve a community-level node based at least on semantic similarity and retrieve linked embedding identifiers for downstream inference. In another example, the agent system 110 can rank summaries and generate a follow-up query based at least on a selected node, updating the result by referencing associated short-term context and/or working context entries.

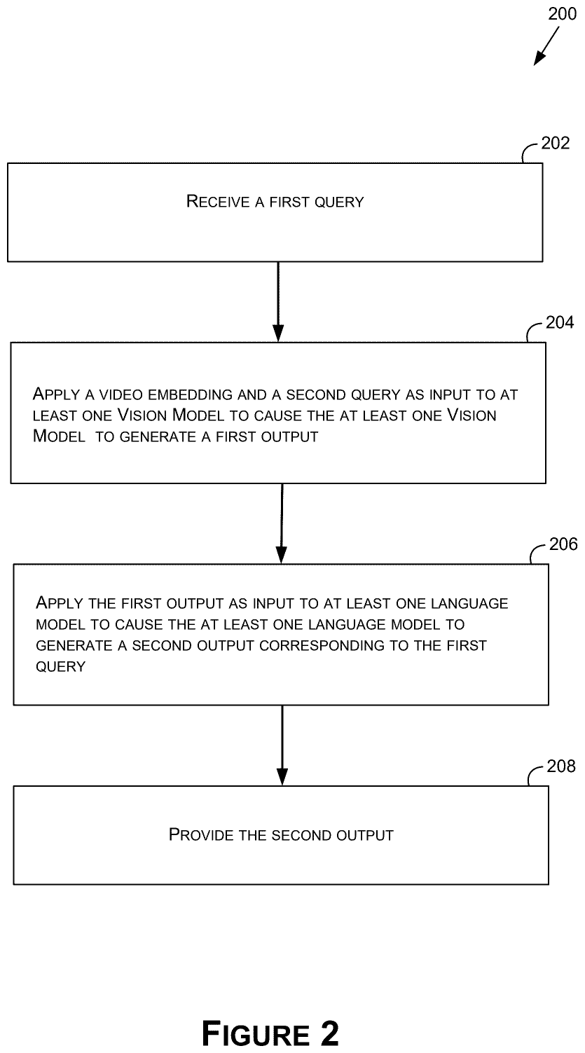

Now referring to FIG. 2, each block of method 200, described herein, includes a computing process that can be performed using any combination of hardware, firmware, and/or software. For instance, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

Referring now to FIG. 2, a flow diagram showing a method 200 for context-aware video retrieval and inference, in accordance with some implementations of the present disclosure. The method 200, at block 204, includes receiving, via an interface, a first query (e.g., natural language input, such as “when did the person place the box?”) corresponding to an event in at least one video sequence. The event can be a specific occurrence or action in the event (e.g., motion, interaction, temporal segment). The video sequence can be of a recording, capture instance, and/or live-stream.

The method 200, at block 204, includes applying at least one video embedding of a plurality of video embeddings (e.g., represented by short video segments) and a second query (e.g., task specific, such as “Did a person fall?”, vid_emd0) corresponding to at least one language model as input to at least one video model to cause the at least one video model to generate a first output corresponding to the second query. That is, a video embedding identifier corresponding to the video embedding can identify the relevant video embedding for modeling. An embedding identifier (e.g., vid_emdN) can be identified using the language model and/or performing a similarity search on a video index. The first output can be a caption, label, and/or description. The second query can correspond to a generated query by a language model.

The method 200, at block 206, includes applying (e.g., input the VLM output to the LLM) the first output as input to the at least one language model to cause the at least one language model to generate a second output corresponding to the first query. That is, the at least one language model can be configured (e.g., implemented, trained, updated) to generate the second output based at least on context data. The output of the video model and/or contexts can be used to answer the original query of the user.

The method 200, at block 208, includes providing, via the interface, the second output. For example, the second output can be “The box was placed by a person in a yellow vest at 1:04:12.”

In some implementations, the processing circuits can apply the first query as input to the at least one language model to cause the at least one language model to generate the second query corresponding to at least one function to perform. That is, the processing circuits can feed the initial question by the user to the language model. The second query can be a sub-task and/or system-facing instruction. For example, the function to perform can retrieve video metadata (e.g., embedding identifiers) from a graph or a video index in storage, calling the video model, and/or fetching from a memory queue.

In some implementations, the context data corresponds to at least one of a system context, a long-term context, or a short-term context. In some implementations, the processing circuits can generate the second query by causing the at least one language model to access at least one of the system context, the long-term context, or the short-term context. In some implementations, the processing circuits can retrieve (e.g., invoke or perform a retrieval operation) at least one token corresponding to the system context or the long-term context. In some implementations, the processing circuits can retrieve a summary (e.g., recursive summary buffer) of one or more historical queries. In some implementations, the processing circuits can retrieve a queue of one or more recent queries (e.g., queue size can determine the number of recent queries stored).

In some implementations, the processing circuits can update the long-term context (e.g., working context) based at least on applying at least one input to at least one of the at least one language model, the at least one video model, or an embedding system. In some implementations, the processing circuits can update the short-term context (e.g., summary and/or queue) based at least on a plurality of queries received.

In some implementations, the processing circuits can obtain a model-compatible representation (e.g., a machine-processable representation and/or tensor-based data representation, such as frame-aligned data arrays, batched image sequences, and/or any encoded format compatible with neural model processing) of video data corresponding to the at least one video sequence. In some implementations, the processing circuits can preprocess and/or otherwise format the video data into a model-compatible representation (e.g., a structured data format). In some implementations, the processing circuits can segment and/or chunk a plurality of frames of the video data into a plurality of video segments (e.g., short videos and/or temporal chunks) based at least on one of a segmentation parameter (e.g., fixed-length duration such as 5 seconds or 20 frames, adaptive segmentation) corresponding to a domain (e.g., event type, context-aware such as scene cut detection, and/or task-specific such as per play) of the at least one video sequence or a frame sampling parameter (e.g., how frames are selected, such as every N frames, keyframes only, based at least on motion). In some implementations, the processing circuits can generate, using an embedding system, the plurality of video embeddings based at least on the plurality of video segments, wherein the plurality of video embeddings correspond to a live video stream or recorded video data.

In some implementations, the processing circuits can select the at least one video model from a plurality of video models based at least on the domain. In some implementations, the processing circuits can apply at least one of (i) the plurality of embeddings, (ii) at least one caption, (iii) at least a portion of a graph as input to the at least one video model to generate metadata corresponding to the video data. In some implementations, the processing circuits can determine that the metadata includes at least one label (e.g., semantic targets, caption, or description, such as bounding box labels, activity recognition, scene classifications, and/or higher-level events) indicating at least one object, action, scene attribute, or event class detected from a corresponding video embedding of the plurality of video embeddings. In some implementations, the processing circuits can store the metadata in a database indexed by at least one identifier corresponding to at least one of the plurality of video embeddings.

In some implementations, the processing circuits can generate a graph (e.g., structured representation of metadata relationships) based at least on metadata. For example, a video model can be used to generate the graph. In some implementations, the graph can include a plurality of nodes (e.g., semantic nodes) and a plurality of edges (e.g., capturing temporal or contextual dependencies). In some implementations, the plurality of nodes represent a plurality of labels. In some implementations, the plurality of edges represent a plurality of semantic relationships between at least two of the plurality of nodes.

In some implementations, the processing circuits can traverse the graph based at least on the second query to identify at least one node or at least one edge corresponding to a label of the plurality of labels or a semantic relationship of the plurality of semantic relationships. In some implementations, the processing circuits can identify at least one of the plurality of video embeddings corresponding to a detected object, action, scene attribute, or event class represented by the identified at least one node or the identified at least one edge.

In some implementations, the processing circuits can apply a third query corresponding to the at least one language model as input to the at least one video model to cause the at least one video model to generate a third output corresponding to the third query. In some implementations, the processing circuits can identify, using the at least one language model, a timestamp and a duration based at least on the third output and the context data. In some implementations, the processing circuits can obtain, using an embedding system, at least one additional video embedding based at least on the timestamp and the duration (e.g., when a portion of a video is not available, such as not previously chunked, the processing circuits can perform embedding generation in real-time (or near real-time) to obtain the relevant video embedding). In some implementations, the processing circuits can apply the at least one of the additional video embedding, a fourth query corresponding to the at least one language model, and/or corresponding metadata as input to the at least one video model to cause the at least one video model to generate a fourth output corresponding to the fourth query.

The systems and methods described herein can be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medical systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multimodal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

Referring now to FIG. 3, a system 300 implemented as part of the system 100 of FIG. 1 to process long-form video input and execute agentic inference operations based at least on multimodal query processing, in accordance with some implementations of the present disclosure. A user can submit a natural language query via the query 302 and/or provide at least one video 304 to the agent system 110. In some implementations, the query can cause the agent system 110 to identify the at least one video 304. The agent system 110 can process the video 304 using the embedding system 306. For example, the embedding system 306 can apply one or more computer vision (CV) models 308 (e.g., object detection, pose estimation, and action recognition) to generate low-level metadata features (e.g., represented as object bounding boxes, pose keypoints, and/or temporal action labels). The embedding generator 310 can segment the video 304 into a plurality of chunks based at least on a configurable parameter (e.g., CHUNK_LENGTH, segmentation parameter corresponding to a domain of the at least one video sequence, and/or a frame sampling parameter), and generate chunk-level video embeddings 312 for at least one (e.g., each) segment. The embedding generator 310 can also apply one or more predefined scenario prompts to the video model(s) 116 to generate responses 314. The text-to-embedding converter 316 can transform the textual responses 314 into embedding representations, which can be output by the embedding system 306 for storage as part of the video indexing data and/or video embedding data in the model database 118.

The model database 118 can include a video index 330 (also referred to herein as a “video index model”) and a video embedding database 332. The video embedding database 332 can store the chunk-level video embeddings 312 and the scenario prompt embeddings generated by the text-to-embedding converter 316. The video index 330 can organize the video indexing data and provide indexing functions based at least on attributes, temporal segments, and/or feature vectors to the video context system 328 of the context system 112. In some implementations, the video context system 328 can use the indexed embeddings to associate retrieved segments with prior query threads, summaries, and/or graph-based memory structures. The video context system 328 can interface with the video model(s) 116 and the language model(s) 114 during retrieval planning and response generation. The context system 112 also includes the short-term context system 320. The short-term context system 320 can access, generate, and store interaction data in the short-term context 324 (e.g., data storage and/or data structure, such as in memory) and provide read-write access to working contexts, summaries, and/or queues for inference operations by the language model(s) 114 and/or the video model(s) 116.

In the agent system 110, the agent interface 326 can facilitate execution coordination across the language model(s) 114 and the video model(s) 116 using the VLM system 322 and/or the function executor system 318. That is, the agent interface 326 can manage control signals and data routing to coordinate inference flows between the language model(s) 114, the video model(s) 116, and the context system 112 during query resolution. The VLM system 322 can generate intermediate representations or query plans that determine whether the input query should be resolved using caption embeddings, video embeddings, image-level QA, and/or a combination thereof. That is, the VLM system 322 can process outputs from the video model(s) 116 and convert them into structured outputs to be routed via the agent interface 326 to components within or external to the context system 112. The function executor system 318 can be used to interpret LLM-generated function calls and/or invoke retrieval or inference tasks using the video context system 328 and/or short-term context system 320. That is, the function executor system 318 can receive structured outputs from the language model(s) 114 and use the agent interface 326 to access or update memory, perform data lookups, or request execution of corresponding video or language operations. Based at least on the outputs from the embedding generator 310 and the stored records in the model database 118, the system 300 can generate a final response 334 using the outputs from the language model(s) 114 and/or video model(s) 116. In some implementations, the agent system 110 can perform integrated multimodal processing and context-aware reasoning over long-form video data by facilitating embedding generation, memory storage, and/or segment retrieval across the components of the agent system 110.

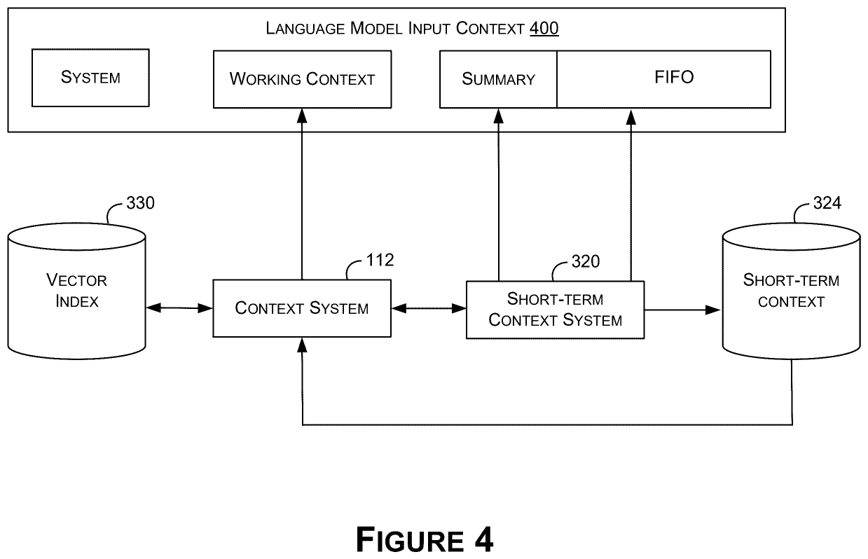

Referring now to FIG. 4, a language model input context 400, in accordance with some implementations of the present disclosure. The language model input context 400 can represent a structured input container and/or data structure that includes any one or more of a system context, a working context, and/or a short-term context including a summary and FIFO queue. The context system 112 can manage the working context by retrieving structured records such as video embedding identifiers, activity counters, and/or other intermediate data relevant to a current query or task. The short-term context system 320 can manage access to the short-term context 324, including recently stored message summaries and FIFO-ordered responses (or other order type queues). The short-term elements can be selectively provided into the language model input context 400 for processing. The system context within the language model input context 400 can include persistent metadata and identifiers representing long-term configuration and cross-session state. The context system 112 can retrieve vector representations from the vector index 330 and selectively merge them into the working context for inclusion in the language model input context 400. The context system 112 and the short-term context system 320 can interface to construct the context view reflected in the language model input context 400, combining stored memory from the short-term context 324 and the vector index 330.

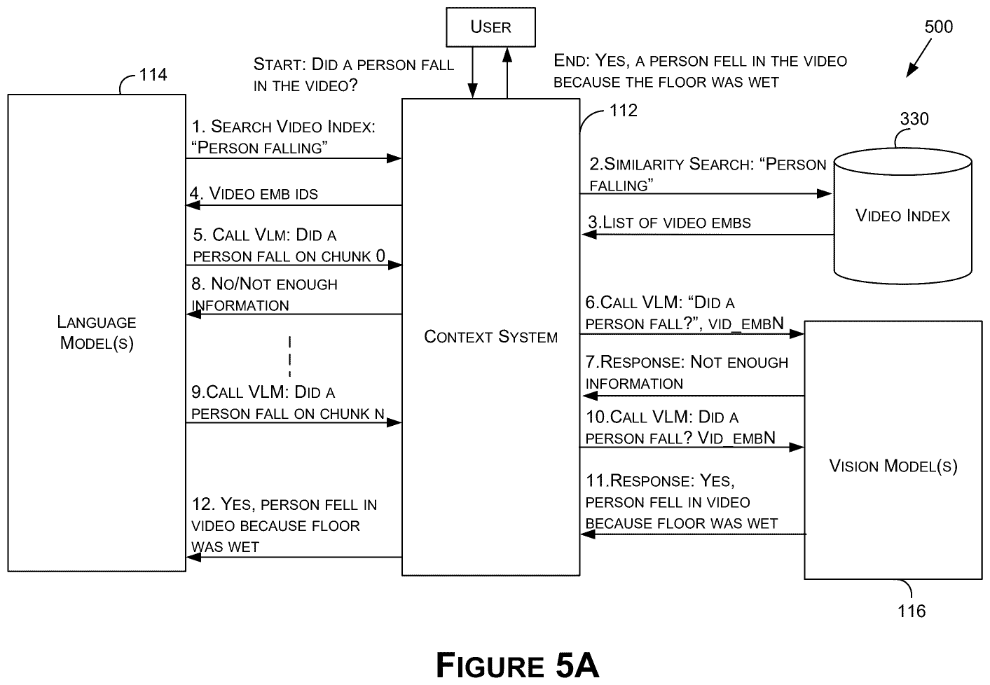

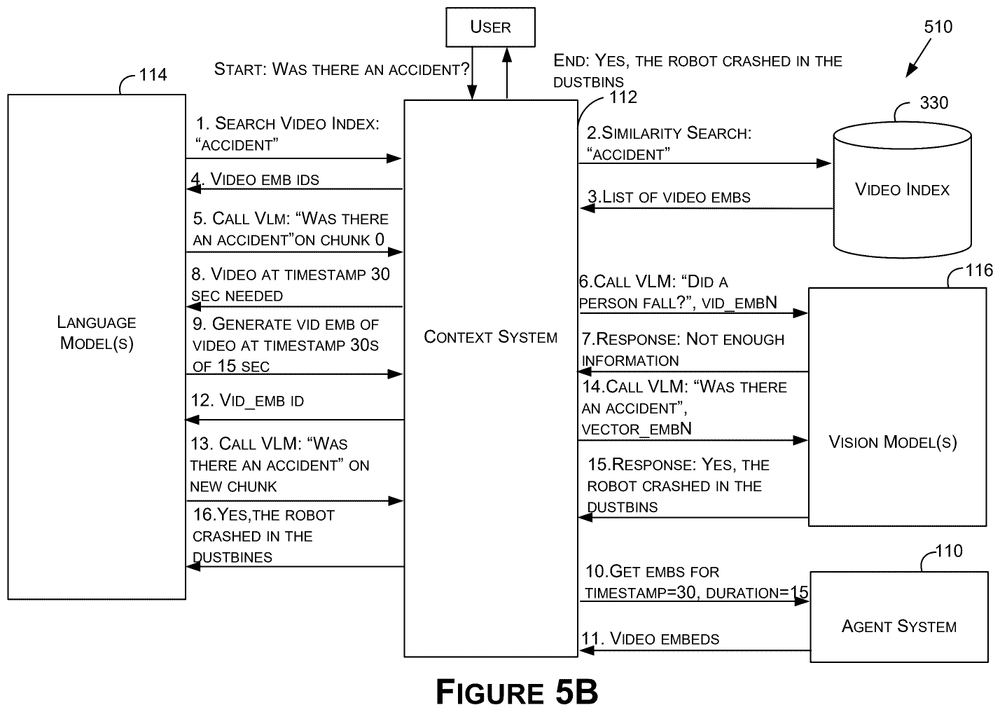

Referring now to FIG. 5A, an example interaction 500 performed by components of the agent system 110 to resolve a natural language query, in accordance with some implementations of the present disclosure. The agent system 110 can use both the language model(s) 114 and the video model(s) 116 in combination with the context system 112 and the video index 330. At step 1, the language model(s) 114 initiate a search over the video index 330 for a query-specific concept (e.g., “person falling”). At step 2, the context system 112 can perform a similarity search based at least on the received query string, issuing a request to the video index 330. At step 3, the video index 330 returns a list of video embeddings corresponding to segments potentially relevant to the query. At step 4, the embedding identifiers can be returned to the language model(s) 114 for use in downstream inference. At step 5, the language model(s) 114 can instruct the context system 112 to query the video model(s) 116, using the video embedding corresponding to chunk 0. At step 6, the context system 112 can issue the request to the video model(s) 116. At step 7, the video model(s) 116 can return an inference output indicating that the chunk does not contain sufficient information to determine whether a person fell. Steps 8-10 repeat the process iteratively across additional chunks (e.g., chunk N), with the language model(s) 114 sequentially prompting the context system 112 to evaluate whether the target event occurred. At step 11, the video model(s) 116 identify a chunk containing both the target event and a causal condition (e.g., the floor was wet). At step 12, the language model(s) 114 consolidate the response and output the final result to the user.

Referring now to FIG. 5B, another example interaction 510 performed by components of the agent system 110 to resolve a natural language query, in accordance with some implementations of the present disclosure. At step 1, the language model(s) 114 initiate a search of the video index 330 for the concept “accident.” At step 2, the context system 112 performs a similarity search based at least on the query, and at step 3, the video index 330 returns a list of relevant video embeddings. At step 4, the language model(s) 114 receive the embedding identifiers and initiate a visual language model (VLM) query on chunk 0 (step 5) to assess whether an accident occurred. At step 5, the language model(s) 114 use can provide a prompt such as “Was there an accident on chunk 0?” to the video model 116. Based at least on the available chunk, the video model(s) 116 return an insufficient response at step 6, which is passed through the context system 112 and recorded by the language model(s) 114 as “not enough information” at step 7. To refine the query, the language model(s) 114 can determine that a more specific segment (e.g., video at timestamp 30 seconds) is needed (step 8). The language model(s) 114 can issue a request at step 9 to generate a new video embedding corresponding to the segment starting at 30 seconds with a duration of 15 seconds. At step 10, the context system 112 can pass this request to the agent system 110 (e.g., the embedding system 306), to output video embeddings at step 11. The newly generated embedding identifier can be returned to the language model(s) 114 at step 12. At step 13, the language model(s) 114 can call the video model(s) 116 again using the timestamp-specific embedding to ask, “Was there an accident?” In turn, the context system 112 can send the same refined query and embedding (vector_embN) to the video model(s) 116 at step 14. At step 15, the video model(s) 116 respond that “Yes, the robot crashed in the dustbins.” At step 16, the language model(s) 114 return a final answer to the user indicating that an accident occurred because the robot crashed in the dustbins.

### Example Language Models

In at least some implementations, language models, such as large language models (LLMs), vision language models (VLMs), multimodal language models (MMLMs), and/or other types of generative artificial intelligence (AI) can be implemented. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based at least on the context provided in input prompts or queries. These language models can be considered “large,” in implementations, based at least on the models being trained on massive datasets and having architectures with large number of learnable network parameters (weights and biases)—such as millions or billions of parameters. The LLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure can be used exclusively for text processing, in implementations, whereas in other implementations, multimodal LLMs can be implemented to accept, understand, and/or generate text and/or other types of content like images, audio, 2D and/or 3D data (e.g., in USD formats), and/or video. For example, vision language models (VLMs), or more generally multimodal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based at least on instructions in a given prompt) to access one or more plug-ins (e.g., 3rd party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 6A is a block diagram of an example generative language model system 600 suitable for use in implementing at least some implementations of the present disclosure. Generally, the example generative language model system 600 can perform query analysis, instruction generation, and context interpretation for multimodal agentic processing. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which can include an LLM, a VLM, a multimodal LM, etc.).

At a high level, the input processor 605 can receive an input 601 including text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 630 (e.g., LLM/VLM/MMLM/etc.). In some implementations, the input 601 includes plain text in the form of one or more sentences, paragraphs, and/or documents. Additionally, or alternatively, the input 601 can include numerical sequences, precomputed embeddings (e.g., word or sentence embeddings), and/or structured data (e.g., in tabular formats, JSON, or XML). In some implementations in which the generative LM 630 is capable of processing multimodal inputs, the input 601 can combine text (or can omit text) with image data, audio data, video data, design data, USD data, and/or other types of input data, such as but not limited to those described herein. Taking raw input text as an example, the input processor 605 can prepare raw input text in various ways. For example, the input processor 605 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 605 can remove stopwords to reduce noise and focus the generative LM 630 on more meaningful content. The input processor 605 can apply text normalization, for example, by converting all characters to lowercase, removing accents, and/or or handling special cases like contractions or abbreviations to ensure consistency. These are just a few examples, and other types of input processing can be applied.

In some implementations, a RAG component 692 (which can include one or more RAG models, and/or can be performed using the generative LM 630 itself) can be used to retrieve additional information to be used as part of the input 601 or prompt. RAG can be used to enhance the input to the LLM/VLM/MMLM/etc. with external knowledge, so that answers to specific questions or queries or requests are more relevant-such as in a case where specific knowledge is required. The RAG component 692 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 601 can be generated using the query or input to the model (e.g., a question, a request, etc.) in addition to data retrieved using the RAG component 692. In some implementations, the input processor 605 can analyze the input 601 and communicate with the RAG component 692 (or the RAG component 692 can be part of the input processor 605, in implementations) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 can retrieve a prior stored conversation history—or at least a summary thereof—and include the prior conversation history along with the current ask/request as part of the input 601 to the generative LM 630.

The RAG component 692 can use various RAG techniques. For example, naive RAG can be used where documents are indexed, chunked, and applied to an embedding model to generate embeddings corresponding to the chunks. A user query can also be applied to the embedding model and/or another embedding model of the RAG component 692 and the embeddings of the chunks along with the embeddings of the query can be compared to identify the most similar/related embeddings to the query, which can be supplied to the generative LM 630 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naive and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 692 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a REST interface plug-in such that the graph database is decoupled from the vector database and/or the embeddings models.

The tokenizer 610 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy can depend on factors such as the language being processed, the task at hand, and/or characteristics of the training dataset. As such, the tokenizer 610 can convert the (e.g., processed) text into a structured format according to tokenization schema being implemented in the particular implementation.

The embedding component 620 can use any known embedding technique to transform discrete tokens into (e.g., dense, continuous vector) representations of semantic meaning. For example, the embedding component 620 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data/video data/etc., the input processor 605 can resize the data to a standard size compatible with format of a corresponding input channel and/or can normalize pixel values to a common range (e.g., 0 to 1) to ensure a consistent representation, and the embedding component 620 can encode the image data using any known technique (e.g., using one or more convolutional neural networks (CNNs) to extract visual features). In some implementations in which the input 601 includes audio data, the input processor 605 can resample an audio file to a consistent sampling rate for uniform processing, and the embedding component 620 can use any known technique to extract and encode audio features-such as in the form of a spectrogram (e.g., a mel-spectrogram). In some implementations in which the input 601 includes video data, the input processor 605 can extract frames or apply resizing to extracted frames, and the embedding component 620 can extract features such as optical flow embeddings or video embeddings and/or can encode temporal information or sequences of frames. In some implementations in which the input 601 includes multimodal data, the embedding component 620 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LM system 600 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 can apply an encoded representation of the input 601 to the generative LM 630, and the generative LM 630 can process the encoded representation of the input 601 to generate an output 690, which can include responsive text and/or other types of data.

As described herein, in some implementations, the generative LM 630 can be configured to access or use—or capable of accessing or using—plug-ins/APIs 695 (which can include one or more plug-ins, application programming interfaces (APIs), databases, data stores, repositories, etc.). For example, for certain tasks or operations that the generative LM 630 is not ideally suited for, the model can have instructions (e.g., as a result of training, and/or based at least on instructions in a given prompt, such as those retrieved using the RAG component 692) to access one or more plug-ins/APIs 695 (e.g., 3rd party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 695 to the plug-in/API 695, the plug-in/API 695 can process the information and return an answer to the generative LM 630, and the generative LM 630 can use the response to generate the output 690. This process can be repeated—e.g., recursively—for any number of iterations and using any number of plug-ins/APIs 695 until an output 690 that addresses each ask/question/request/process/operation/etc. from the input 601 can be generated. As such, the model(s) can not only rely on its own knowledge from training on a large dataset(s) and/or from data retrieved using the RAG component 692, but also on the expertise or optimized nature of one or more external resources—such as the plug-ins/APIs 695.

FIG. 6B is a block diagram of an example implementation in which the generative LM 630 includes a transformer encoder-decoder. Generally, the generative LM 630 can generate structured outputs, such as follow-up queries or function calls, based at least on natural language input and context embeddings. For example, assume input text such as “Who discovered gravity” is tokenized (e.g., by the tokenizer 610 of FIG. 6A) into tokens such as words, and each token is encoded (e.g., by the embedding component 620 of FIG. 6A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 640 can convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 can generate a first token, and the generation mechanism 655 can apply the generated token as an input during a second pass. The process can repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 can output some decoded (e.g., vector) representation of the input being applied during a particular pass. The classifier 650 can include a multi-class classifier including one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 can select or sample a word or token based at least on a corresponding predicted probability (e.g., select the word with the highest predicted probability) and append it to the output from a previous pass, generating each word or token sequentially. The generation mechanism 655 can repeat the process, triggering successive decoder inputs and corresponding predictions until selecting or sampling a symbol or token that represents the end of the response, at which point, the generation mechanism 655 can output the generated response.

FIG. 6C is a block diagram of an example implementation in which the generative LM 630 includes a decoder-only transformer architecture. For example, the decoder(s) 660 of FIG. 6C can operate similarly as the decoder(s) 645 of FIG. 6B except each of the decoder(s) 660 of FIG. 6C omits the encoder-decoder self-attention layer (since there is no encoder in this implementation). As such, the decoder(s) 660 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 660. As with the decoder(s) 645 of FIG. 6B, each token (e.g., word) can flow through a separate path in the decoder(s) 660, and the decoder(s) 660, a classifier 665, and a generation mechanism 670 can use auto-regression to sequentially generate one token at a time until predicting a symbol or token that represents the end of the response. The classifier 665 and the generation mechanism 670 can operate similarly as the classifier 650 and the generation mechanism 655 of FIG. 6B, with the generation mechanism 670 selecting or sampling each successive output token based at least on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 7 is a block diagram of an example computing device(s) 700 suitable for use in implementing some implementations of the present disclosure. Generally, the computing device(s) 700 can execute components of the agent system 110, including embedding generation, context retrieval, and model inference. Computing device 700 can include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one implementation, the computing device(s) 700 can include one or more virtual machines (VMs), and/or any of the components thereof can include virtual components (e.g., virtual hardware components). For non-limiting examples, one or more of the GPUs 708 can include one or more vGPUs, one or more of the CPUs 706 can include one or more vCPUs, and/or one or more of the logic units 720 can include one or more virtual logic units. As such, a computing device(s) 700 can include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some implementations, a presentation component 718, such as a display device, can be considered an I/O component 714 (e.g., if the display is a touch screen). As another example, the CPUs 706 and/or GPUs 708 can include memory (e.g., the memory 704 can be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 can represent one or more links or busses, such as an address bus, a data bus, a control bus, or a combination thereof. The interconnect system 702 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 706 can be directly connected to the memory 704. Further, the CPU 706 can be directly connected to the GPU 708. Where there is direct, or point-to-point connection between components, the interconnect system 702 can include a PCIe link to carry out the connection. In these examples, a PCI bus need not be included in the computing device 700.

The memory 704 can include any of a variety of computer-readable media. The computer-readable media can be any available media that can be accessed by the computing device 700. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 704 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computing device 700. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 706 can be configured to execute at least some of the computer-readable instructions to control one or more components of the computing device 700 to perform one or more of the methods and/or processes described herein. The CPU(s) 706 can each include one or more cores (e.g., one, two, four, eight, twenty-eight, seventy-two, etc.) that are capable of handling a multitude of software threads simultaneously. The CPU(s) 706 can include any type of processor, and can include different types of processors depending on the type of computing device 700 implemented (e.g., processors with fewer cores for mobile devices and processors with more cores for servers). For example, depending on the type of computing device 700, the processor can be an Advanced RISC Machines (ARM) processor implemented using Reduced Instruction Set Computing (RISC) or an x86 processor implemented using Complex Instruction Set Computing (CISC). The computing device 700 can include one or more CPUs 706 in addition to one or more microprocessors or supplementary co-processors, such as math co-processors.

In addition to or alternatively from the CPU(s) 706, the GPU(s) 708 can be configured to execute at least some of the computer-readable instructions to control one or more components of the computing device 700 to perform one or more of the methods and/or processes described herein. One or more of the GPU(s) 708 can be an integrated GPU (e.g., with one or more of the CPU(s) 706 and/or one or more of the GPU(s) 708 can be a discrete GPU. In implementations, one or more of the GPU(s) 708 can be a coprocessor of one or more of the CPU(s) 706. The GPU(s) 708 can be used by the computing device 700 to render graphics (e.g., 3D graphics) or perform general purpose computations. For example, the GPU(s) 708 can be used for General-Purpose computing on GPUs (GPGPU). The GPU(s) 708 can include hundreds or thousands of cores that are capable of handling hundreds or thousands of software threads simultaneously. The GPU(s) 708 can generate pixel data for output images in response to rendering commands (e.g., rendering commands from the CPU(s) 706 received via a host interface). The GPU(s) 708 can include graphics memory, such as display memory, for storing pixel data or any other suitable data, such as GPGPU data. The display memory can be included as part of the memory 704. The GPU(s) 708 can include two or more GPUs operating in parallel (e.g., via a link). The link can directly connect the GPUs (e.g., using NVLINK) or can connect the GPUs through a switch (e.g., using NVSwitch). When combined together, each GPU 708 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 706 and/or the GPU(s) 708, the logic unit(s) 720 can be configured to execute at least some of the computer-readable instructions to control one or more components of the computing device 700 to perform one or more of the methods and/or processes described herein. In implementations, the CPU(s) 706, the GPU(s) 708, and/or the logic unit(s) 720 can discretely or jointly perform any combination of the methods, processes and/or portions thereof. One or more of the logic units 720 can be part of and/or integrated in one or more of the CPU(s) 706 and/or the GPU(s) 708 and/or one or more of the logic units 720 can be discrete components or otherwise external to the CPU(s) 706 and/or the GPU(s) 708. In implementations, one or more of the logic units 720 can be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 can include one or more receivers, transmitters, and/or transceivers that allow the computing device 700 to communicate with other computing devices via an electronic communication network, included wired and/or wireless communications. The communication interface 710 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 720 and/or communication interface 710 can include one or more data processing units (DPUs) to transmit data received over a network and/or through interconnect system 702 directly to (e.g., a memory of) one or more GPU(s) 708.

The I/O ports 712 can allow the computing device 700 to be logically coupled to other devices including the I/O components 714, the presentation component(s) 718, and/or other components, some of which can be built in to (e.g., integrated in) the computing device 700. Illustrative I/O components 714 include a microphone, mouse, keyboard, joystick, game pad, game controller, satellite dish, scanner, printer, wireless device, etc. The I/O components 714 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 can be include depth cameras, such as stereoscopic camera systems, infrared camera systems, RGB camera systems, touchscreen technology, and combinations of these, for gesture detection and recognition. Additionally, the computing device 700 can include accelerometers or gyroscopes (e.g., as part of an inertia measurement unit (IMU)) that allow detection of motion. In some examples, the output of the accelerometers or gyroscopes can be used by the computing device 700 to render immersive augmented reality or virtual reality.

The power supply 716 can include a hard-wired power supply, a battery power supply, or a combination thereof. The power supply 716 can provide power to the computing device 700 to allow the components of the computing device 700 to operate.

The presentation component(s) 718 can include a display (e.g., a monitor, a touch screen, a television screen, a heads-up-display (HUD), other display types, or a combination thereof), speakers, and/or other presentation components. The presentation component(s) 718 can receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that can be used in at least one implementations of the present disclosure. Generally, the example data center 800 can support distributed execution of the agent system 110 using scalable compute resources for model inference and video processing. The data center 800 can include a data center infrastructure layer 810, a framework layer 820, a software layer 830, and/or an application layer 840.

As shown in FIG. 8, the data center infrastructure layer 810 can include a resource orchestrator 812, grouped computing resources 814, and node computing resources (“node C.R.s”) 816(1)-816(N), where “N” represents any whole, positive integer. In at least one implementation, node C.R.s 816(1)-816(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 816(1)-816(N) can correspond to a server having one or more of the above-mentioned computing resources. In addition, in some implementations, the node C.R.s 816(1)-8161(N) can include one or more virtual components, such as vGPUs, vCPUs, and/or the like, and/or one or more of the node C.R.s 816(1)-816(N) can correspond to a virtual machine (VM).

In at least one implementation, grouped computing resources 814 can include separate groupings of node C.R.s 816 housed within one or more racks (not shown), or many racks housed in data centers at various geographical locations (also not shown). Separate groupings of node C.R.s 816 within grouped computing resources 814 can include grouped compute, network, memory or storage resources that can be configured or allocated to support one or more workloads.

In at least one implementation, several node C.R.s 816 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 812 can configure or otherwise control one or more node C.R.s 816(1)-816(N) and/or grouped computing resources 814. In at least one implementation, resource orchestrator 812 can include a software design infrastructure (SDI) management entity for the data center 800. The resource orchestrator 812 can include hardware, software, or some combination thereof.

In at least one implementation, as shown in FIG. 8, framework layer 820 can include a job scheduler 828, a configuration manager 834, a resource manager 836, and/or a distributed file system 838. The framework layer 820 can include a framework to support software 832 of software layer 830 and/or one or more application(s) 842 of application layer 840. The software 832 or application(s) 842 can respectively include web-based service software or applications, such as those provided by Amazon Web Services, Google Cloud and Microsoft Azure. The framework layer 820 can be, but is not limited to, a type of free and open-source software web application framework such as Apache Spark™ (hereinafter “Spark”) that can use distributed file system 838 for large-scale data processing (e.g., “big data”). In at least one implementation, job scheduler 828 can include a Spark driver to facilitate scheduling of workloads supported by various layers of data center 800. The configuration manager 834 can be capable of configuring different layers such as software layer 830 and framework layer 820 including Spark and distributed file system 838 for supporting large-scale data processing. The resource manager 836 can be capable of managing clustered or grouped computing resources mapped to or allocated for support of distributed file system 838 and job scheduler 828. In at least one implementation, clustered or grouped computing resources can include grouped computing resource 814 at data center infrastructure layer 810. The resource manager 836 can coordinate with resource orchestrator 812 to manage these mapped or allocated computing resources.

In at least one implementation, software 832 included in software layer 830 can include software used by at least portions of node C.R.s 816(1)-816(N), grouped computing resources 814, and/or distributed file system 838 of framework layer 820. One or more types of software can include, but are not limited to, Internet web page search software, e-mail virus scan software, database software, and streaming video content software.

In at least one implementation, application(s) 842 included in application layer 840 can include one or more types of applications used by at least portions of node C.R.s 816(1)-816(N), grouped computing resources 814, and/or distributed file system 838 of framework layer 820. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 834, resource manager 836, and resource orchestrator 812 can implement any number and type of self-modifying actions based at least on any amount and type of data acquired in any technically feasible fashion. Self-modifying actions can relieve a data center operator of data center 800 from making possibly bad configuration decisions and possibly avoiding underutilized and/or poor performing portions of a data center.

The data center 800 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 800. In at least one implementation, trained or deployed machine learning models corresponding to one or more neural networks can be used to infer or predict information using resources described above with respect to the data center 800 by using weight parameters calculated through one or more training techniques, such as but not limited to those described herein.

In at least one implementation, the data center 800 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 700 of FIG. 7—e.g., each device can include similar components, features, and/or functionality of the computing device(s) 700. In addition, where backend devices (e.g., servers, NAS, etc.) are implemented, the backend devices can be included as part of a data center 800, an example of which is described in more detail herein with respect to FIG. 8.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 700 described herein with respect to FIG. 7. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors to execute operations comprising:
receive a first query corresponding to an event at least partially depicted in at least one video sequence;
apply at least one video embedding and a second query corresponding to at least one language model as input to at least one video model to cause the at least one video model to generate a first output corresponding to the second query; and
apply the first output as input to the at least one language model to cause the at least one language model to generate a second output corresponding to the first query.

2. The system of claim 1, wherein the one or more processors are further to execute operations comprising:
apply the first query as input to the at least one language model to cause the at least one language model to generate the second query corresponding to at least one function to perform.

3. The system of claim 1, wherein the at least one language model is to generate the second output based at least on context data corresponding to at least one of (i) a system context, (ii) a long-term context, or (iii) a short-term context.

4. The system of claim 3, wherein the one or more processors execute operations to generate the second query including causing the at least one language model to access at least one of (i) the system context, (ii) the long-term context, or (iii) the short-term context by retrieving, from a memory storage, at least one of: (i) at least one token corresponding to the system context or the long-term context, (ii) a summary of one or more historical queries, or (iii) a queue of one or more recent queries.

5. The system of claim 3, wherein the one or more processors are further to execute operations comprising:
update the long-term context based at least on applying at least one input to at least one of: (i) the at least one language model, (ii) the at least one video model, or (iii) an embedding system; and
update the short-term context based at least on a plurality of queries received.

6. The system of claim 1, wherein the one or more processors are further to execute operations comprising:
obtain a model-compatible representation of video data corresponding to the at least one video sequence;
segment a plurality of frames of the video data in the model-compatible representation into a plurality of video segments based at least on one of a segmentation parameter corresponding to a domain of the at least one video sequence or a frame sampling parameter; and
generate, using an embedding system, the plurality of embeddings based at least on the plurality of video segments, wherein the plurality of embeddings correspond to a live video stream or recorded video data.

7. The system of claim 6, wherein the one or more processors are further to execute operations comprising:
apply at least one of: (i) the plurality of embeddings, (ii) at least one caption, (iii) or at least a portion of a graph, as input to the at least one video model to cause the at least one video model to generate metadata corresponding to the video data, wherein the metadata comprises at least one label indicating at least one object, action, scene attribute, or event class detected from a corresponding video embedding of the plurality of embeddings; and
store the metadata in a database indexed by at least one identifier corresponding to at least one of the plurality of embeddings.

8. The system of claim 1, wherein the one or more processors are further to execute operations comprising:
generate a graph based at least on metadata, the graph comprising a plurality of nodes and a plurality of edges, the plurality of nodes representing a plurality of labels, and the plurality of edges representing a plurality of semantic relationships between at least two of the plurality of nodes.

9. The system of claim 8, wherein the one or more processors are further to execute operations comprising:
traverse the graph based at least on the second query to identify at least one node or at least one edge corresponding to a label of the plurality of labels or a semantic relationship of the plurality of semantic relationships; and
identify at least one embedding corresponding to a detected object, action, scene attribute, or event class represented by the identified at least one node or the identified at least one edge.

10. The system of claim 1, wherein the one or more processors are further to execute operations comprising:
apply a third query corresponding to the at least one language model as input to the at least one video model to cause the at least one video model to generate a third output corresponding to the third query;
identify, using the at least one language model, a timestamp and a duration based at least on the third output and context data;
obtain, using an embedding system, at least one of an additional video embedding or corresponding metadata based at least on the timestamp and the duration; and
apply the at least one of the additional video embedding or the corresponding metadata and a fourth query corresponding to the at least one language model as input to the at least one video model to cause the at least one video model to generate a fourth output corresponding to the fourth query.

11. The system of claim 1, wherein the one or more processors are further to execute operations comprising:
a system implementing generation of embeddings based at least on domain-specific segmentation and sampling parameters;
a system implementing context-aware retrieval-augmented generation over long-form video data;
a system implementing multimodal query processing using one or more large language models (LLMs) and one or more vision-language models;
a system implementing temporal alignment or semantic alignment between user queries and video segments using model-generated metadata;
a system for updating a context responsive to language model queries;
a system implementing one or more multi-modal language models (MMLMs);
a system implementing the LLMs;
a system implementing one or more small language models (SLMs);
a system implementing one or more vision language models (VLMs);
a system for generating synthetic data;
a system for generating synthetic data using AI;
a control system for an autonomous or semi-autonomous machine;
a perception system for an autonomous or semi-autonomous machine;
a system for performing digital twin operations;
a system for performing light transport simulation;
a system for performing remote operations;
a system implemented using an edge device;
a system implemented using a robot;
a system for performing conversational AI operations;
a system incorporating one or more virtual machines (VMs);
a system implemented at least partially in a data center; or
a system implemented at least partially using cloud computing resources.

12. One or more processors comprising processing circuitry to:
receive a first query corresponding to an event in at least one video sequence;
apply at least one video embedding identifier and a second query corresponding to at least one language model as input to at least one video model to cause the at least one video model to generate a first output corresponding to the second query; and
apply the first output as input to the at least one language model to cause the at least one language model to generate a second output corresponding to the first query, the at least one language model to generate the second output based at least on context data corresponding to at least one of the first query, the second query, the at least one video model, or the at least one language model.

13. The one or more processors of claim 12, wherein the processing circuitry is further to:
apply the first query as input to the at least one language model to cause the at least one language model to generate the second query corresponding to at least one function to perform.

14. The one or more processors of claim 12, wherein the context data corresponds to at least one of: (i) a system context, (ii) a long-term context, or (iii) a short-term context.

15. The one or more processors of claim 14, wherein the processing circuitry is further to generate the second query including causing the at least one language model to access at least one of: (i) the system context, (ii) the long-term context, or (iii) the short-term context by retrieving at least one of: (i) at least one token corresponding to the system context or the long-term context, (ii) a summary of one or more historical queries, or (iii) a queue of one or more recent queries.

16. The one or more processors of claim 14, wherein the processing circuitry is further to:
update the long-term context based at least on applying at least one input to at least one of: (i) the at least one language model, (ii) the at least one video model, or (iii) an embedding system; and
update the short-term context based at least on a plurality of queries received.

17. The one or more processors of claim 12, wherein the processing circuitry is further to:
segment a plurality of frames of video data corresponding to the at least one video sequence into a plurality of video segments based at least on one of a segmentation parameter corresponding to a domain of the at least one video sequence or a frame sampling parameter; and
generate, using an embedding system, a plurality of video embeddings based at least on the plurality of video segments, wherein the plurality of video embeddings correspond to a live video stream or recorded video data.

18. The one or more processors of claim 17, wherein the processing circuitry is further to:
select the at least one video model from a plurality of video models based at least on the domain;
apply at least the plurality of video embeddings as input to the at least one video model to cause the at least one video model to generate metadata corresponding to the video data, wherein the metadata comprises at least one label indicating at least one object, action, scene attribute, or event class detected from a corresponding video embedding of the plurality of video embeddings; and
store the metadata in a database indexed by at least one identifier corresponding to at least one of the plurality of video embeddings.

19. The one or more processors of claim 12, wherein the processing circuitry is further to:
generate a graph based at least on metadata, the graph comprising a plurality of nodes and a plurality of edges, the plurality of nodes representing a plurality of labels, and the plurality of edges representing a plurality of semantic relationships between at least two of the plurality of nodes.

20. A method, comprising:
receiving, by one or more processors, a query corresponding to an event in at least one video sequence;
generating, by the one or more processors using at least one video model, a first output based at least on at least one video embedding of a plurality of embeddings;
generating, by the one or more processors using at least one language model, a second output corresponding to the query based at least on context data and the first output; and
providing, by the one or more processors, the second output.
